(19) United States
(12) Patent Application Publication
(10) Pub. No.: US 2026/0161680 A1
(43) Pub. Date: Jun. 11, 2026

(54) GENERATIVE MODEL BASED QUERY LANGUAGE GENERATION FOR DATE TIME EXPRESSIONS

(71) Applicant: Oracle International Corporation, Redwood Shores, CA (US)

(72) Inventors: Duy Vu, Melbourne (AU); Nagesh Panyam Chandrasekarasastry, Melbourne (AU); Gioacchino Tangari, Sydney (AU); Cong Duy Vu Hoang, Wantima South (AU); Yakupitiyage Don Thanuja Samodhye Dharmasiri, Melbourne (AU); Thanh Long Duong, Melbourne (AU); Anshuk Pal Chaudhuri, Bengaluru (IN); Karthik Puthenparampil Srinivasan, Kottayam (IN); Kok Wei Kam, Box Hill (AU); Prabhakara Reddy Munnangi, Hyderabad (IN); Subhash Kumar Bhamidipati, Issaquah, WA (US)

(73) Assignee: Oracle International Corporation, Redwood Shores, CA (US)

(21) Appl. No.: 19/255,059

(22) Filed: Jun. 30, 2025

Related U.S. Application Data
(60) Provisional application No. 63/729,250, filed on Dec. 6, 2024.

(51) Int. Cl. G06F 16/3329; G06F 16/334

(52) U.S. Cl. CPC G06F 16/3329; G06F 16/334

(57) ABSTRACT

Techniques are disclosed herein towards logical form data-time expression generation. For example, methods are provided for receiving a natural language (NL) utterance, generating a prompt including the NL utterance and instructions to transform the NL utterance into a logical form query including a coded-form expression, generating, by a generative model based on the prompt, a logical form query including a coded-form expression, transforming the coded-form expression into a period definition expression by executing the coded-form expression with one or more pre-defined period-definition content items, updating the logical form query to include the period definition expression by replacing the coded-form expression with the period definition expression, and providing at least one of i) the updated logical form query or ii) a query result obtained based on the updated logical form query, to a client system.

### CROSS-REFERENCE TO RELATED APPLICATION

The present application is a non-provisional application of and claims the benefit and priority under 35 U.S.C. 119 (e) of U.S. Provisional Application No. 63/729,250, filed on Dec. 6, 2024, the entire contents of which is incorporated herein by reference in its entirety for all purposes.

### FIELD

The present disclosure relates generally to converting natural language to a logical form, and more particularly, to augmenting natural language prompts with instructions and using coded-form expressions to modify logical form (e.g., BI, SQL, etc.) queries.

### BACKGROUND

Databases play an important role in storing, managing, and retrieving information across a broad spectrum of industries, including finance, healthcare, logistics, and research. However, a significant challenge arises from the fact that different databases often use a wide array of data formats for similar types of information. For example, the representation of dates can differ greatly depending on the database management system, organizational protocols, or regional practices. Some databases may use a “YYYY-MM-DD” format (e.g., 2024-06-18), others may use “MM/DD/YYYY” (e.g., Jun. 18, 2024), or “DD.MM.YYYY” (e.g., 18.06.2024), and these differences are often further complicated by varying time zones, localization settings, and the distinction between fiscal and calendar years. This lack of uniformity in data formatting increases the complexity, and thus processing power needs, for any system or user seeking to access, combine, or analyze data from multiple sources.

The absence of standardized data formatting creates a significant obstacle when constructing queries intended to retrieve accurate and meaningful results from different databases. If a query is not tailored to the specific formatting conventions of a target database, it may fail to return the correct records, generate errors, and/or produce misleading results. For instance, a query that searches for records using the date “2024-06-18” may return no matches if the database stores dates as “MM/DD/YYYY,” since the input format would not align with the stored values. In another scenario, a financial report that seeks to aggregate quarterly transactions could yield inconsistent results if databases define fiscal quarters differently or label periods with non-standard nomenclature. Inconsistencies can result in partial, duplicated, or inaccurate data sets, ultimately compromising the dependability of business analytics and operational workflows.

The costs associated with these formatting disparities may be considerable in terms of both resources and efficiency. Organizations frequently invest substantial amounts of time and money in developing custom “middleman” solutions, conversion scripts, and/or tedious manual procedures to manage the wide variety of database formats. For example, integrating data from subsidiaries in different countries may need programmers to design intricate routines to interpret and convert date fields between regional standards, test for all possible format variations, and address exceptions as they arise. This process not only increases development and maintenance expenditures, but also heightens the risk of human error, slows system performance, and/or may delay the delivery of key business insights.

### BRIEF SUMMARY

Prompt engineering and generative model techniques are disclosed herein (e.g., a computer implemented method, a system, non-transitory computer-readable medium storing code or instructions executable by one or more processors) for augmenting natural language prompts with instructions and using coded-form expressions to modify logical form (e.g., SQL) queries.

In some embodiments, a computer-implemented method comprising receiving a natural language (NL) utterance, generating a prompt including the NL utterance and instructions to transform the NL utterance into a logical form query including a coded-form expression, generating, by a generative model based on the prompt, a logical form query including a coded-form expression, transforming the coded-form expression into a period definition expression by executing the coded-form expression with one or more pre-defined period-definition content items, updating the logical form query to include the period definition expression by replacing the coded-form expression with the period definition expression, and providing at least one of i) the updated logical form query or ii) a query result obtained based on the updated logical form query, to a client system.

In some embodiments, prior to providing the query result to the client system, the computer-implemented method further comprises executing the updated logical form query on a query database to obtain the query result.

In some embodiments, the coded-form expression is an executable programming language function that is independent of at least one period definition expression.

In some embodiments, the instructions comprise a task description describing one or more time periods, one or more period functions sharing a programming language format with the coded-form expression, one or more gold truth examples including at least one gold truth logical form query, wherein each gold truth logical form query includes a gold truth coded-form expression, and one or more additional instructions which provide context to the generative model relating to the task description, the one or more period functions, or the one or more gold truth examples.

In some embodiments, generating the logical form query further comprises generating, by the generative model, a first coded-form expression associated with a first portion of the NL utterance, wherein the first portion includes a first time period, and generating, by the generative model, a second coded-form expression associated with a second portion of the NL utterance, wherein the second portion includes a second time period different from the first time period, and wherein the coded-form expression comprises the first coded-form expression and the second coded-form expression; and generating, by the generative model, one or more composite operators associated with a programming language that the coded-form expression is formatted in, wherein the one or more composite operators operate on the first coded-form expression and the second coded-form expression to generate a composite coded-form expression; and wherein transforming the coded-form expression into the period definition expression is based on the composite coded-form expression.

In some embodiments, the computer-implemented method further comprises generating, by the generative model, one or more explanations associated with the updated logical form query, and providing the one or more explanations to the client system.

In some embodiments, the pre-defined period definition content items are library content items associated with one or more programming languages.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL Model, according to various embodiments.

FIG. 5 depicts a simplified diagram for an example natural language to logical form tool translating a natural language utterance into a logical form, according to various embodiments.

FIG. 6 depicts a simplified example of disparate queries for various period definitions, according to various embodiments.

FIG. 7 depicts a simplified block diagram of an example logical form query updating process, according to various embodiments.

FIG. 8 depicts a simplified example of a task description provided to a generative model in a prompt, according to various embodiments.

FIG. 9 depicts simplified examples of data time functions and explanations provided to a generative model in a prompt, according to various embodiments.

FIG. 10 depicts simplified examples of gold truth examples provided to a generative model in a prompt, according to various embodiments.

FIG. 11 depicts simplified examples of additional instructions provided to a generative model in a prompt, according to various embodiments.

FIG. 12 depicts a simplified diagram for an example natural language to logical form tool transforming a natural language utterance into a logical form with an updated period definition expression.

FIG. 13 is a flowchart illustrating an example process for updating a logical form query, according to various embodiments.

FIG. 14 is a block diagram illustrating one pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Introduction

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results require time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query requires a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as large language models (LLMs). An LLM is a type of artificial intelligence (AI) that is trained to understand, generate, and manipulate human language (e.g., text data) in a coherent and contextually relevant manner. LLMs have resulted in significant progress in natural language processing tasks such as text-to-code (e.g., text-to-SQL), text generation and translation, and sentiment analysis. Due to their attention mechanisms and deep neural architectures, LLMs excel at capturing nuanced language patterns and correlations in massive volumes of text data. LLMs are designed to predict the next word or token in a sequence of text by computing a probability distribution over a fixed vocabulary for the next token based on the context of the preceding tokens. The prediction is achieved through a series of self-attention mechanisms incorporated in the LLMs that assign varying degrees of importance to different parts of the input sequence that enable the LLMs to make informed predictions. LLMs generate contextually appropriate and coherent text by learning a fixed vocabulary from enormous text corpora and predicting which token included in the fixed vocabulary should be the next token in an output sequence.

In the modern information economy, databases are used for storage, retrieval, and management of data across diverse fields such as finance, healthcare, logistics, and scientific research. However, these databases frequently employ a wide variety of data formats for similar types of information. For example, storage of date values can appear in formats including “YYYY-MM-DD” (e.g., 2024-06-18), “MM/DD/YYYY” (e.g., 06/18/2024), or “DD.MM.YYYY” (e.g., 18.06.2024) depending on the underlying database management system, organizational practices, and/or regional conventions. Additional complications arise from the use of differing time zones, localization settings, and/or fiscal versus calendar year structures. This lack of standardization creates considerable technical challenges for users and systems tasked with accessing or integrating data across multiple sources.

One consequence of this heterogeneity in multiple sources is the increased difficulty in constructing queries that consistently yield correct results. When a query is not formatted to match the target database's expectations, it may fail to retrieve the intended records, generate runtime errors, and/or produce misleading outcomes. For example, a query searching for entries with a sale date of “2024-06-18” will not return any matches if the database stores dates as “MM/DD/YYYY,” since the string representations do not align. Similarly, when aggregating financial transactions by fiscal quarter, discrepancies in quarter definitions or period-naming conventions across databases can produce incomplete or inaccurate reports. These technical inconsistencies not only undermine the reliability of analytics and reporting but may also propagate errors to downstream systems, causing cascading failures and data integrity issues.

The ramifications of these issues may be significant in both technical and operational terms. Organizations must often devote substantial resources to developing and maintaining middleware, data transformation scripts, and/or manual processes to handle the multitude of formatting variations. For instance, integrating global data sources may prompt the implementation of parsing and conversion routines to interpret date fields in each regional standard, with extensive testing to account for all possible cases. These efforts increase development time, elevate maintenance costs, and introduce the risk of human error. Moreover, performance can be severely impacted when queries need on-the-fly format conversions (e.g., a user requesting assistance creating a valid query) or when repeated query failures necessitate time-consuming troubleshooting and re-execution. These technical challenges can cause delays in decision-making, reduce system throughput, and/or limit an organization's ability to leverage its data assets efficiently and reliably.

Some embodiments of the present disclosure relate to business intelligence (BI) systems, which are used for aggregating, analyzing, and visualizing large volumes of organizational data, are particularly susceptible to the limitations imposed by inconsistent database formats. BI queries often span multiple databases and data warehouses, each with its own conventions for storing dates, numeric values, and/or other important fields. For example, a BI dashboard designed to present year-to-date sales performance may query several systems that each use a different date format or period-naming convention. When BI tools encounter these inconsistencies, the BI tools may either fail to reconcile the disparate data sets or return reports with incomplete or incorrect figures. This not only compromises the accuracy and utility of business analytics, but also increases the burden on information technology (IT) teams, who implement data mapping, transformation, and/or validation layers within the BI environment. As a result, a lack of standardization can diminish the value of BI tools, delay the delivery of insights to users attempting to use the BI tools, and impair a user's and/or organization's ability to make timely, data-driven decisions.

BI systems are integral to modern organizations, as the BI systems enable the aggregation, analysis, and/or visualization of substantial volumes of data from diverse sources. However, these systems are particularly vulnerable to an important problem: the lack of standardization among underlying databases. In practice, BI queries often need to access and reconcile data from multiple databases and data warehouses, each of which may employ its own conventions for storing important fields such as dates, numeric values, and other key metrics. For instance, a BI dashboard designed to provide year-to-date sales performance may have to draw information from several distinct systems, with each system utilizing a unique date format or period-naming convention. These inconsistencies introduce significant challenges. BI tools may fail to reconcile the disparate datasets or may return reports with incomplete or incorrect data. This undermines the reliability and utility of business analytics and places a substantial burden on information technology (IT) teams, who must devise complex data mapping, transformation, and validation layers within the BI environment. The lack of data format standardization diminishes the value of BI tools, delays the delivery of meaningful insights, and impairs both users and organizations in making timely data-driven decisions.

To address these pervasive challenges, the present disclosure introduces methods, devices, systems, components, and techniques that facilitate more robust and seamless BI querying across heterogeneous data sources (e.g., databases). The solution centers on a natural language to logical form (NL2LF) tool, which is capable of receiving natural language requests from users, regardless of their expertise with organization-specific databases or query languages. For example, a user might enter a request such as “Show all revenue for the last fiscal year,” even if they are unfamiliar with the technical intricacies of the underlying data infrastructure. The NL2LF tool leverages advanced generative models, such as machine learning algorithms, to transform these natural language utterances into logical form queries suitable for execution on the relevant databases. The generative model may be pre-trained or may utilize prompts enriched with additional information, including explicit reasoning on how date-time functions should be applied. This enables the model to generalize and generate accurate solutions for a wide variety of user queries, including those involving complex or novel period definitions. In certain embodiments, the generated logical form queries may contain coded-form expressions, such as Python code expressions, that are independent of any specific date or time format. These coded-form expressions are subsequently executed in a suitable computational environment and translated into period definition expressions customized for the target database. By abstracting date-time functionality and separating it from rigid data definitions, this approach reduces the technical barriers associated with traditional BI querying, transforming the process into a more manageable function call generation problem.

The methods and systems described herein offer significant technical advantages that improve the overall efficacy and reliability of BI environments. By enabling seamless interoperability across databases regardless of their underlying data formats, the disclosed NL2LF tool automates the detection and standardization of various date and time conventions, ensuring that queries yield consistent and accurate results even when executed against disparate databases. This automation enhances data integrity and reliability by eliminating format-related errors and reducing the risk of incomplete or erroneous data retrieval. Furthermore, the NL2LF tool streamlines data integration by removing the need for custom intermediary solutions and manual transformation scripts, thereby accelerating project timelines and simplifying both computer system and data structure architectures. The tool also improves query performance by resolving format mismatches in advance using coded-form expressions, reducing computational overhead during query execution. Its adaptability allows organizations to add or migrate databases with minimal configuration effort, as the tool does not need predefined knowledge of every connected database. Additionally, compatibility with leading BI platforms ensures accurate query generation across disparate systems. The NL2LF tool minimizes ongoing maintenance needs, lowers operational costs due to its adaptability, and reduces the likelihood of human error by automating previously manual data handling tasks, thereby delivering a scalable and sustainable solution for organizations.

### II. Overview of Agents and NL2SQL Framework

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing a utterance such as query: “Please retrieve all invoices greater than ten thousand dollars for the last four years for Customer Y”, to the agent, and the agent responding with a natural language response for the query based on translation of the user's natural language query to a SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may convert the content into a standardized logical form (e.g., a SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

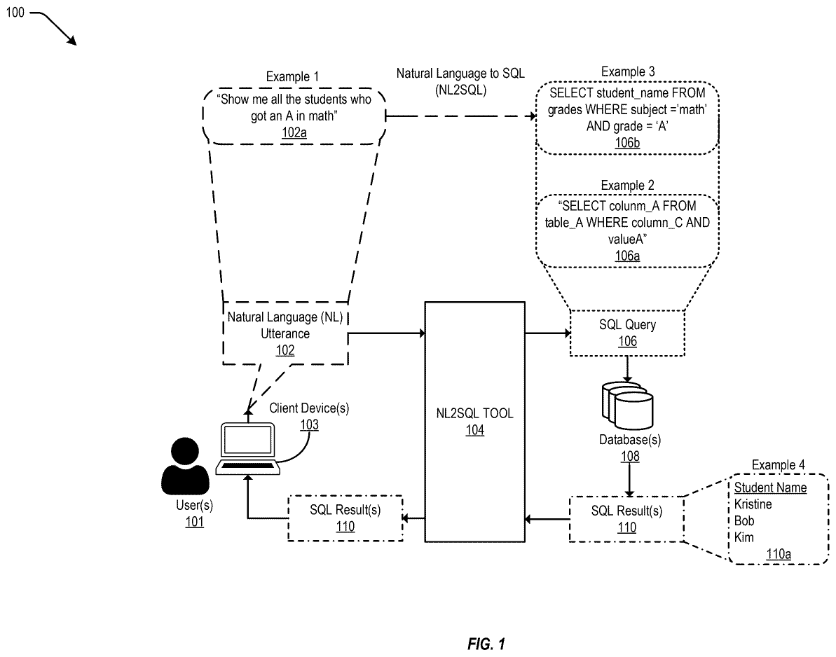

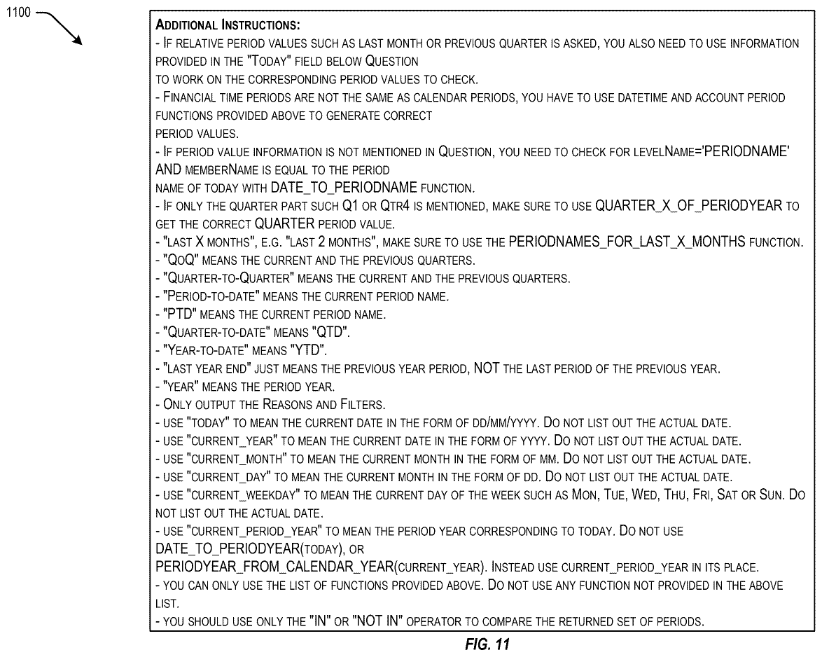

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for query). As shown in FIG. 1, the NL2SQL tool 104 is configured to generate a SQL query 106 and one or more SQL query result(s) 110 based on the provided natural language utterance 102, however other examples may implement tasks in addition to or alternative to SQL query generation (e.g., schema checking, schema linking, sentence completion, extraction of key information, debugging, and other SQL related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 11-15) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensure high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other natural language to logical form (NL2LF) tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the NL2SQL tool 104 via client device(s) 103. The client devices(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone or via a plug-in, or make use of some other audio-to-text translator, configured to translate the audio into text for further processing.

The NL2SQL tool 104 may be or may make use of one or more generative artificial intelligence models such as LLMs configured to generate a SQL query 106 (e.g., 106a or 106b) based on the natural language utterance 102. The NL2SQL tool 104 may receive a prompt including the natural language utterance 102 to generate a SQL query 106 that it is relevant to the user 101 preferences. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., populates slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain a SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via some other means such as an email communication, SMS message, or other type of notification receivable on one or more other computing devices. In some implementations, the SQL query 106 is provided to the user(s) in addition to or without running the SQL query 106 on the database(s) 108 to obtain SQL result(s) 110 (e.g., as part of a feedback request to validate the SQL query 106).

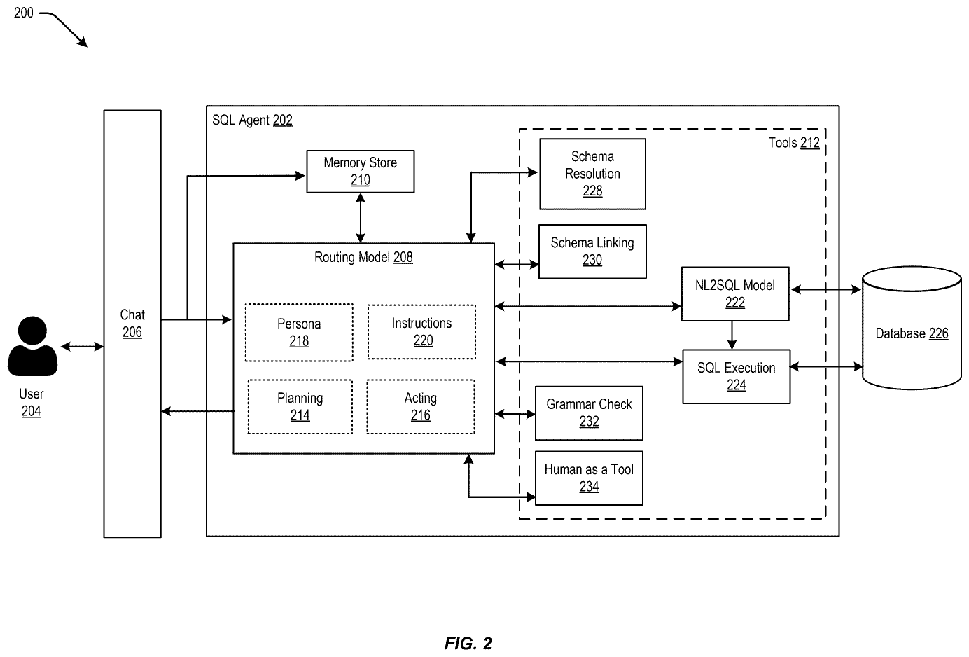

FIG. 2 is a simplified block diagram of a SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence can generate SQL statements. The purpose of the SQL agent system 200 is to enable users to talk to their databases with the least amount of effort. This may include the SQL agent system 200 interpreting user requests in natural language, reviewing database schema, implementing schema linking (i.e. identify names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include a SQL agent 202 capable of converting a natural language question into a SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide a user input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (i.e., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates a SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example | |
|---|---|
| Persona | Example Description |
| Junior | A user having limited to no experience in writing SQL |
| Developer | queries that requires assistance in writing and optimizing |
| | SQL queries. |
| Expert | A user with several years of experience writing SQL |
| Developer | queries. |
| Business | A user with strong context about the needs of a company |
| Analyst | and wants quick data insights without deep SQL knowledge. |
| Data | A user focused on extracting and analyzing data efficiently. |
| Scientist | |

Instructions 220 describe the knowledge bases and tools available to the SQL agent 202. Instructions 220 can be included in a prompt for LLM-based tools and may guide a tool to generate a response relevant to preferences of user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates a SQL query based on the prompt. The NL2SQL model 222 can be trained to convert a natural language question into a SQL query to help the user 204 complete data related tasks. In some examples, the SQL query generated by the NL2SQL model 222 is returned to the user 204 via the chat 206. Additionally, or alternatively, the generated SQL query is provided to a SQL execution 224 tool that is configured to execute SQL queries on the database 226. SQL execution 224 may receive a SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within a SQL statement. The SQL agent 202 may use schema resolution 228 after a SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The SQL agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 206 as received by the routing model 208 (i.e., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a logical form component (e.g., a SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the SQL agent 202 may provide a visualization of the generated output through a plot, table, graph, and the like, via the chat 206. As a particular example, the SQL agent 202 can use the schema linking 230 tool to identify names of table and columns in a natural language utterance (which is an example of NL utterance 102 with respect to FIG. 1) provided by the user 204 and then generate a SQL query using the NL2SQL model 222 based on the identified table and column names. The SQL query may be provided to the user 201 via the chat 206 as generated by the NL2SQL model 222. In some implementations, the routing model 208 may generate a natural language response containing the SQL query and provide the natural language response to the user 201 via the chat 206.

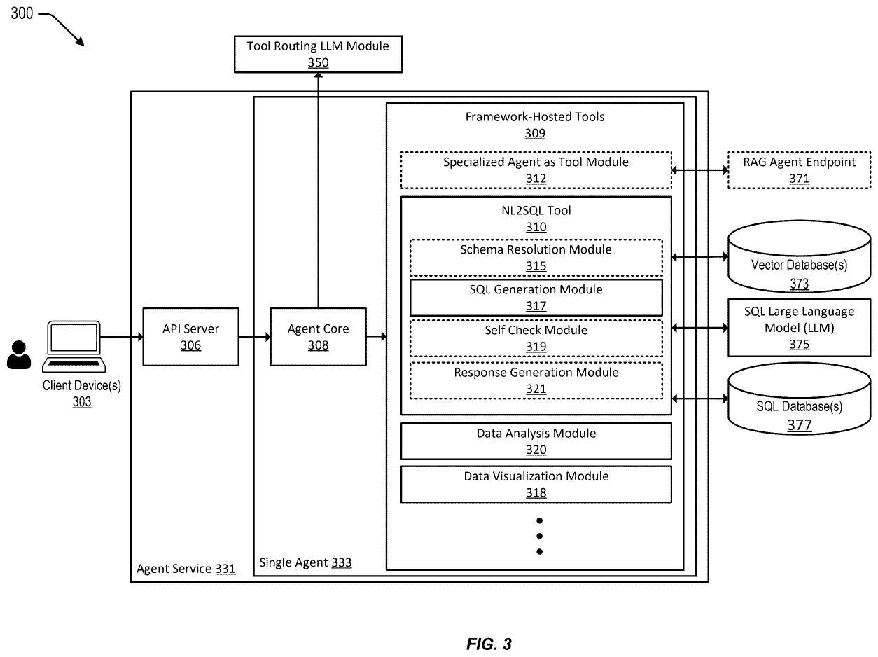

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the frame-work hosted tools 309 is a NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schema for any errors (e.g., syntax errors, sematic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is a SQL generation module 317. The SQL generation module 317 may take the utterance received from the client device(s) 303 and construct a SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of schema, SQL queries, LLM accuracy, recommendations, or suitable equivalents.

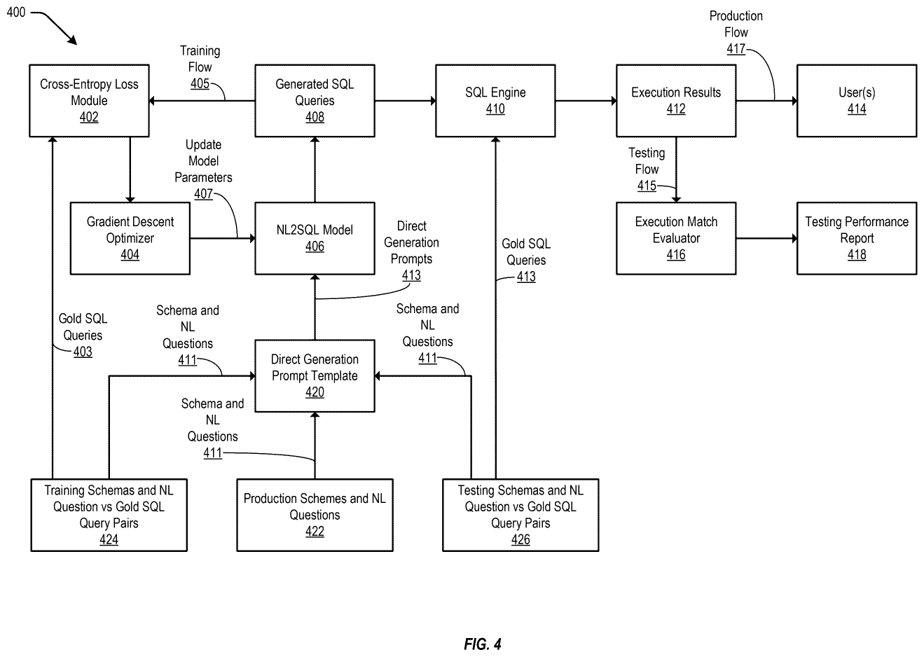

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model(s) (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original data set. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse data sets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is fundamental. By leveraging diverse data sets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse data sets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are valuable to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the below description, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.

For example:
“Get me the list of employees from Australia.”

The main output from the NL2SQL model is a SQL query.

For example:
SELECT employee_id, employee_name FROM Employee WHERE country=“Australia”.

Another important input to the NL2SQL model is the database schema that helps the model to identify relevant tables and columns in the SQL output construction.

For example:

```
CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
...
)
CREATE TABLE JobTitle (
...
)
...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:
Table names
Column names and types
Primary and foreign keys
Other constraints

### One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Each database schema can be associated with multiple pairs of natural language questions and corresponding SQL queries.

Example of NL Question and corresponding SQL Query:
NL Question: “What is the name of the employee with salary greater than 100000 and with the most certificates to fly planes more than 5000?”
SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count(*) DESC LIMIT 1”

Each question-query pair and its corresponding database schema are populated following a NL2SQL direct generation prompt template to create one direct generation prompt example:

### Direction NL2SQL Generation Prompt Example:

Given an input Question, create a syntactically correct Oracle SQL query to run.
Pay attention to using only the column names that you can see in the schema description.
Be careful to not query for columns that do not exist. Also, pay attention to which column is in which table.
Please double check the SQL query you generate.
DO NOT use alias in the SELECT clauses.
Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count(*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count(*) DESC LIMIT 1” is used to evaluate the generated SQL query using a loss function such as cross-entropy loss (e.g., using cross-entropy loss module) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts from which the NL2SQL model generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands required for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using a SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 11-15).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into a SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step requires knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:
“sql
SELECT*FROM customers WHERE signup_date>=DATE_SUB(CURDATE( ), INTERVAL 1 MONTH);
”

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using a SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the required data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may require retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### III. Organization Specific Period Definitions

### Example Descriptions of Disclosure

The description below pertains particularly to logical form queries related to BI but it should be understood that any logical form query could be used without departing from the spirit and scope of the present disclosure.

Throughout this disclosure, the terms “SQL Query” and “SQL Queries” are used to describe a structured command or statement written in Structured Query Language (SQL) that is used to retrieve, manipulate, or manage data within a relational database. However, referencing SQL queries in this disclosure should not be considered limiting, and any suitable equivalent, including queries written in equivalent and/or similar languages or systems that perform equivalent and/or similar data operations, is anticipated within the scope of this disclosure.

Throughout this disclosure, the term “Gold Query” or “Gold Truth Example” is used to describe a definitive and correct logical form query or data retrieval command and/or examples that serves as a benchmark or reference for evaluating the accuracy and efficiency of generated or predicted queries and/or examples within a database system. However, this definition should not be considered limiting, and any suitable equivalent, including alternative representations of reference queries, examples, or validation standards, is anticipated within the scope of this disclosure.

Throughout this disclosure, the term “Generative Model” is used to describe a computational system or algorithm designed to generate outputs, such as text, images, or code, based on learned patterns and relationships from training data, often employing techniques like neural networks or probabilistic modeling. However, this definition should not be considered limiting, and any suitable equivalent, including machine learning models utilizing different architectures or methodologies to produce generative outputs, is anticipated within the scope of this disclosure.

Throughout this disclosure, the term “Natural Language Utterance” is used to describe a spoken, signed (e.g., American/French/British Sign Language, etc.), or written expression in a human language, that conveys a user's intention or query and can be processed or interpreted by computational systems for tasks like translation, information retrieval, or conversational AI. However, this definition should not be considered limiting, and any suitable equivalent, including alternative forms of human language and/or equivalent machine language (or code) input or communication, is anticipated within the scope of this disclosure.

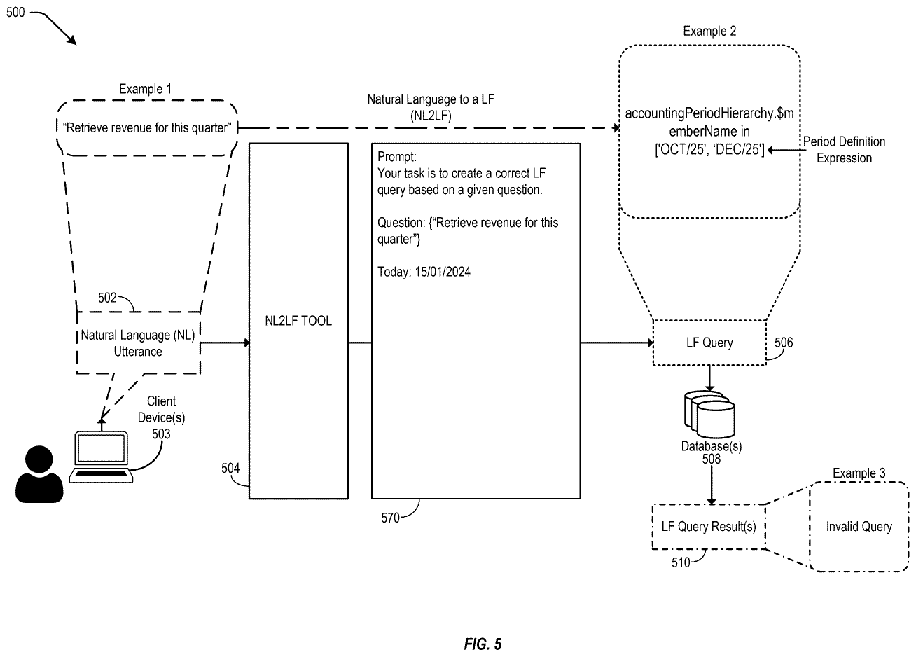

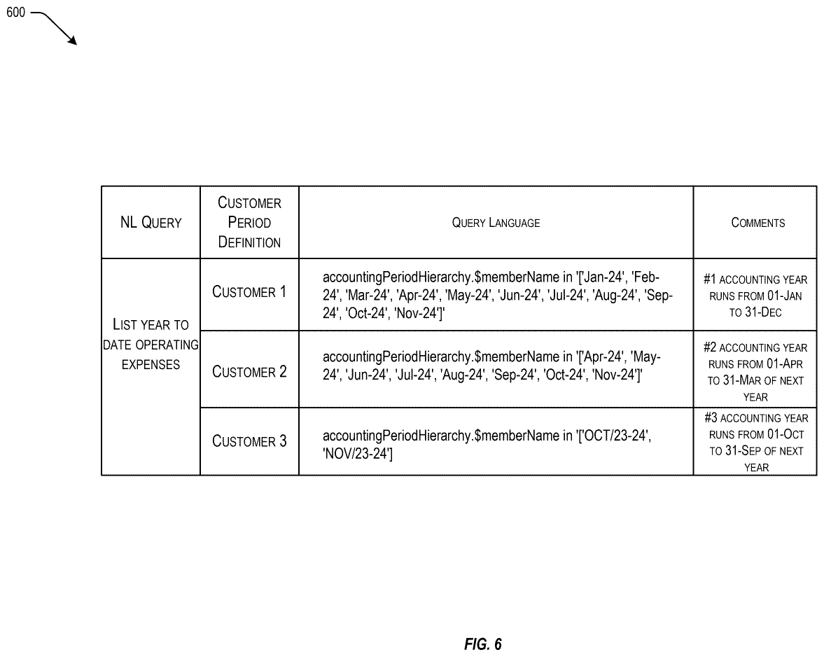

As discussed above with respect to FIGS. 1-3, generative models may be used to translate NL utterances into structured database queries, allowing users to interact with data systems through intuitive, conversational inputs. While the generative model may lower a technical barrier for database access and improve user productivity, the generative model's effectiveness depends on accurately interpreting user intent and generating syntactically and semantically correct queries tailored to the target database's schema and formatting conventions. If the generative model produces a query that is incorrectly formatted (e.g., using the wrong date syntax, data type, or structural element), the database may return invalid results, generate errors, and/or fail to execute the query entirely limiting the reliability and utility of the generative model. These technical deficiencies are depicted in FIGS. 5 and 6.

FIG. 5 depicts a simplified diagram 500 for an example natural language to logical form tool translating a natural language utterance into a logical form. FIG. 5 depicts a scenario where an incorrect date-time format is used on a database, where the date-time format is shown in FIG. 6 for a period definition for Customer 3. As discussed above and similar to FIG. 1, one or more client device(s) 503 submits a natural language (NL) utterance 502 to a component of a NL2SQL tool 504 (e.g., a chatbot). This can happen when a user is accessing a specific website or server requesting information. For example, a user can attempt to pull payable records from an accounting database by chatting (e.g., chat 206) with a chatbot (e.g., SQL agent 202) hosted (or linked) to the website and provide the utterance, “Retrieve revenue for this quarter”.

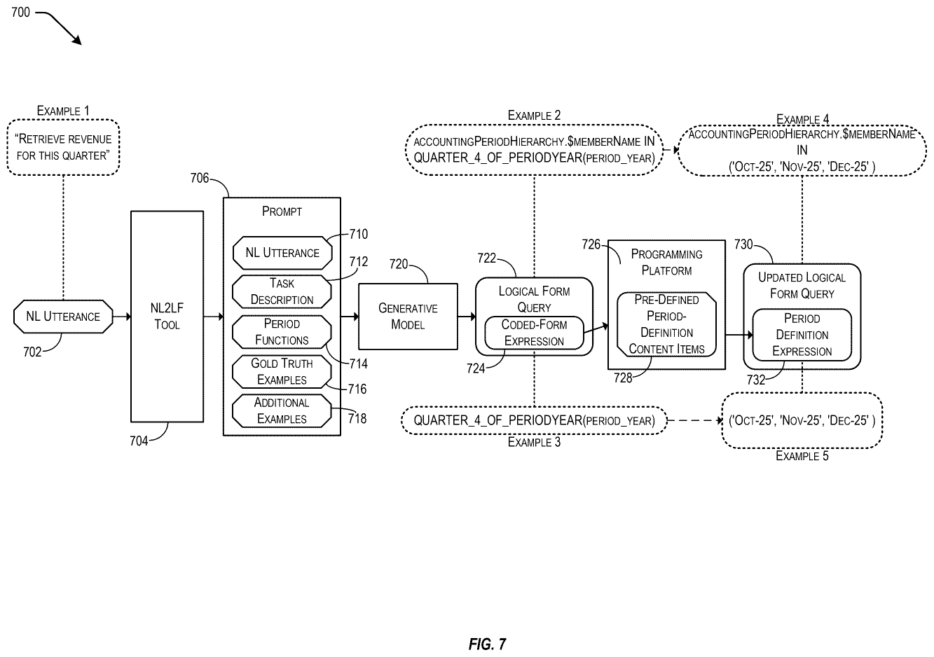

The NL utterance 502 is received by one or more NL2SQL tools 504. To process the question, the NL2SQL tool 504 appends (or otherwise adds) the NL utterance 502 to a baseline prompt 570 along with one or more instructions (discussed in more detail with respect to FIG. 6) so that a generative model (e.g., SQL large language model 375) may translate (or otherwise transform) the NL utterance 502 to a logical form such as SQL query 506. The prompt 570 includes the NL utterance, as in Example 1, as a section in the prompt 570 along with a timestamp (e.g., Today 15/01/2024). In some examples, the timestamp may be optional. The NL2SQL tool 504 provides the prompt 570, which includes the NL utterance 502, to the generative model (not depicted, described in more detail in FIG. 7). A LF query 506 may be generated by the generative model based at least in part on the NL utterance 502 and instructions within the prompt 570. The LF query 50 (e.g., Example 2) may include a logical form query (e.g., “accountingPeriodHierarchy.$memberName in”) along with a period definition (e.g., ‘[‘OCT/25, ‘DEC/25’]) by the generative model to one or more database(s) 508 (e.g., BI database(s) 508) and the database(s) 508 provide one or more LF query result(s) 510. In this non-limiting example, the NL2LF tool 504 may not have prior knowledge of the structure of the database(s) 508 and may provide the wrong format of the LF query 506 to the database(s) which results in an invalid query as in Example 3 since the database(s) may only accept period definitions according to a different format which the NL2LF tool 504 is currently unaware of.

FIG. 6 depicts a simplified example of disparate queries 600 for various period definitions, according to various embodiments. A period definition refers to the specific way time intervals, (e.g., as days, months, quarters, or years) are established, named, and organized within a data system, and these definitions can differ substantially among organizations. For example, one organization may define its fiscal year as beginning in January, with quarters labeled as “Q1-2024” to represent January through March, while another may start its fiscal year in July, causing “Q1-FY2024” to cover July through September. Period labeling conventions also vary, with some entities using “Jan-24” and others using “2024-01” to denote the same month, and certain industries adopting unique periods like four-week promotional cycles or a 4-4-5 calendar (e.g., retail organizations). These diverse approaches for each unique customer period definition create technical challenges as discussed above. In a non-limiting example, a BI query requesting sales for “Q2” may generate results for April through June in one database and for October through December in another, depending on the underlying period definition.

### IV. Logical Form Query Updating

To address the technical challenges created by differing period definitions and data formats across disparate databases, the present disclosure introduces a process that leverages coded-form expressions as an intermediary step in query generation. When a user (or client device) provides a natural language (NL) utterance, (e.g., a request for sales data from the last fiscal quarter), the system first processes this utterance through a generative model that is guided by specific instructions embedded in the prompt. These instructions direct the model to produce a logical form query in a standardized format, which includes a coded-form expression written in a programming language such as Python. The coded-form expression operates as a universal representation of the user's request, abstracted from the idiosyncrasies of any one database's period-naming conventions or date-time formats. This abstraction is important because it neutralizes the differences in how disparate databases define time periods, mitigating or entirely elimination a need for the user or the IT team to manually adapt queries for each unique system.

Once the coded-form expression has been generated by a generative model, it may be executed in a computational environment equipped with a set of pre-defined period-definition content items. These content items may include a library of functions and rules that are capable of interpreting the coded-form expression and transforming it into a period definition expression that is compatible with a target database. The coded-form expression may act as a bridge between the user's original intent and the technical needs of each specific data source. For example, if one database uses a “YYYY-QX” format for quarters and another uses a range of specific start and end dates, the coded-form expression can be mapped to each system's needs using the relevant transformation functions. This ensures that the same natural language query can be accurately and efficiently executed across any number of disparate databases without the need for manual intervention or custom scripting.

By employing coded-form expressions as a standardized intermediary, the system overcomes the technical challenges discussed above associated with inconsistent period definitions and data formats. This approach not only streamlines the process of query generation and execution by automating the adaptation of requests to each database's needs, but also significantly reduces operational overhead and complexity. Organizations are thus able to maintain high levels of data integrity and reliability, as the risk of errors or omissions due to manual data handling is minimized. Furthermore, this method enables rapid scalability, as new databases or changes in period definitions can be accommodated simply by updating the relevant transformation functions, without needing a complete overhaul of the BI infrastructure. The use of coded-form expressions provides a powerful and flexible solution that enhances the interoperability, accuracy, and efficiency of business intelligence systems operating in heterogeneous data environments.

FIG. 7 depicts a simplified block diagram of an example logical form query updating process 700, according to various embodiments. While the process 700 may begin after one or more NL utterances 702 are provided to the NL2LF tool 704 from a client device, as in FIG. 1, it should not be considered limiting, and the process 700 may begin by input of a user, developer, and/or generative model. In some embodiments, the process 700 may include more or fewer steps than the number depicted in FIG. 7. It should be appreciated that the steps of the process 700 may be performed in any suitable order. The process 700 may be performed by some or all components of systems, devices, and/or include the processes, flows, steps, methods, or techniques as those described in relation to FIGS. 1-6 and/or 8-18.

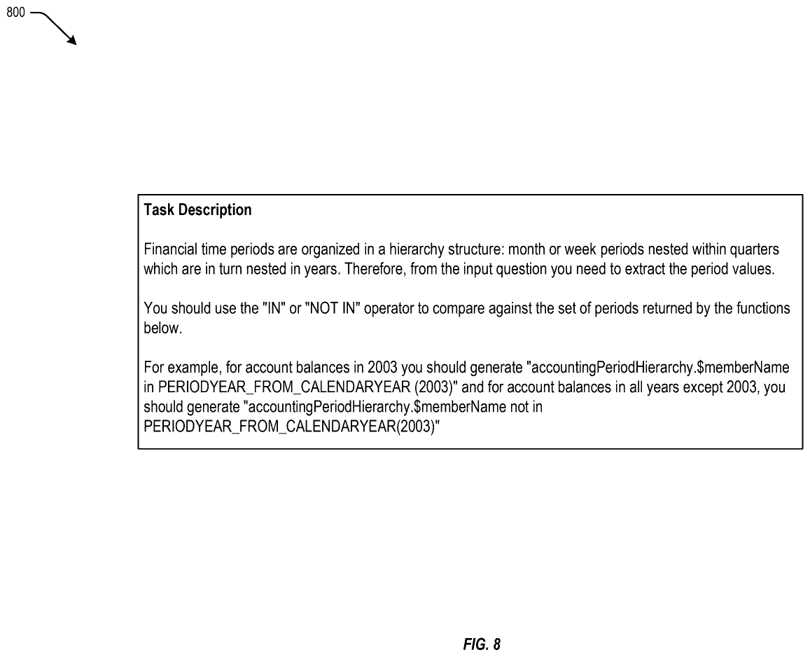

A NL utterance 702 (e.g., retrieve revenue for this quarter) may be received by a NL2LF tool 704 (e.g., a chatbot) (as discussed in more detail with respect to FIG. 1). The NL2LF tool 704 generates a prompt based at least in part on the NL utterance 702 along with several subcomponents. In order to standardize a logical form query to include period definitions for a specific database, the NL2LF tool 704 may perform several operations. For examples, the prompt 706 may include a task description 712, one or more period functions 714, gold truth examples 716, and/or additional examples 718. Each of these subcomponents are discussed in more detail with respect to FIGS. 8-11. The prompt 706 is passed to a generative model 720 for processing.

The generative model 720 may use the prompt 706 and subcomponents of the prompt 706 in order to generate a logical form query 722 which includes a coded-from expression. The generative model 720 may include various machine learning model types, without limitation, neural networks, convolutional neural networks, and recurrent neural networks (e.g., language modeling for text generation), OpenAI™ GPT-4 (e.g., translating a user's question into a SQL query), Google™ BERT-base (e.g., mapping business questions to structured database queries), Facebook™ AI's ROBERTa-large (e.g., semantic parsing of user instructions into query language), Meta™ Llama 2 (e.g., generating SPARQL queries from text prompts), Microsoft's Turing-NLG (e.g., automating report generation by converting requests into SQL), Google™ T5 (Text-to-Text Transfer Transformer) (e.g., converting natural language requests into BigQuery statements), OpenAI™ Codex (e.g., generating SQL queries from plain English), Anthropic's Claude 2 (e.g., constructing BI dashboard queries from conversational requests), Salesforce™ CodeGen (e.g., producing API queries), or combinations thereof.

The generative model 720 generates the logical form query 722 (e.g., accountingPeriodHierarchy.$memberName IN

QUARTER_4_OF_PERIODYEAR(period_year)) which includes a coded-form expression 724 (e.g., QUARTER_4_OF_PERIODYEAR(period_year)) by referencing the subcomponents of the prompt 706 which include coded-form expression definitions. The coded-form expression may be independent of one or more period definitions (as discussed in FIG. 6) associated with specific organization databases. The logical form query 722 (as in Example 2) is provided to a programming platform 726 (e.g., a compiler) along with one or more pre-defined period-definition content items. By way of a non-limiting example, the programming platform 726 may include Python, Java, C++, JavaScript, C#, Ruby, PHP, suitable equivalents, or combinations thereof. One or more pre-defined period-definition content items 728 may be created (automatically or by a user) and include a number of functions (e.g., thirty functions) to aid in transforming the coded-form expression 724 into a period definition expression 732 that is able to be executed on a database. The pre-defined period-definition content items 728 may be library content items (e.g., files) specific to the desired programming platform 726. In a non-limiting example, for Python, Python libraries can be pre-defined to encapsulate period definitions, providing reusable code structures and functions that standardize how time intervals (e.g., as months, quarters, or fiscal years) are identified, labeled, and managed. The library content items may include algorithms for mapping suitably arbitrary dates (from the NL utterance) to the correct period label (e.g., DATE_TO_QUARTER(datetime_str)), conversion utilities for translating period definitions between different business rules or organizational standards, and configurable parameters to accommodate custom calendars or naming conventions specific to databases. In some examples, the NL2LF tool 704 may extract the coded-form expression 724 and provide it to the programming platform 726. In some examples, the pre-defined period-definition content items may execute the coded-form expression directly.

The programming platform 726 executes the coded-form expression 724 with the one or more pre-defined period definition content items 728 and outputs a period definition expression 732 (e.g., (‘October-25’, ‘November-25’, ‘December-25’)) for the NL2FL tool 704 to update the logical form query 722 to generated an updated logical form query 730 (e.g., accountingPeriodHierarchy.$memberName IN (‘October-25’, ‘November-25’, ‘December-25’)) which includes the period definition expression 732. The updated logical form query 730 may be provided directly back to the user (e.g., client device 503) and/or may be executed on the database to obtain a query result, where the query result may also be provided to the user.

FIG. 8 depicts a simplified example of a task description 800 provided to a generative model in a prompt, according to various embodiments. The task description 800 may be an example of task description 712. The task description 800 may include an instruction or a set of instructions provided within a prompt (e.g., prompt 706) that guides the generative model (e.g., generative model 720) in performing a particular operation. Task descriptions 800 may be used to define an objective, context, and/or any constraints under which the generative model should operate. For example, the task description 800 may instruct a generative model to “convert the following natural language question into a LF query,” clarifying to the generative model both the nature of the input (e.g., NL utterance) and an expected output (e.g., a logical form query). The precision and clarity of the task description 800 may directly impact a performance and reliability of the generative model. For example, specifying constraints such as “for account balances in 2003 you should generate “accountingPeriodHierarchy.$memberName in PERIODYEAR_FROM_CALENDARYEAR(2003)” and for account balances in all years except 2003, you should generate “accountingPeriodHierarchy.$memberName not in PERIODYEAR_FROM_CALENDARYEAR(2003)” ensures that the generated query will generate an appropriate coded-form expression.

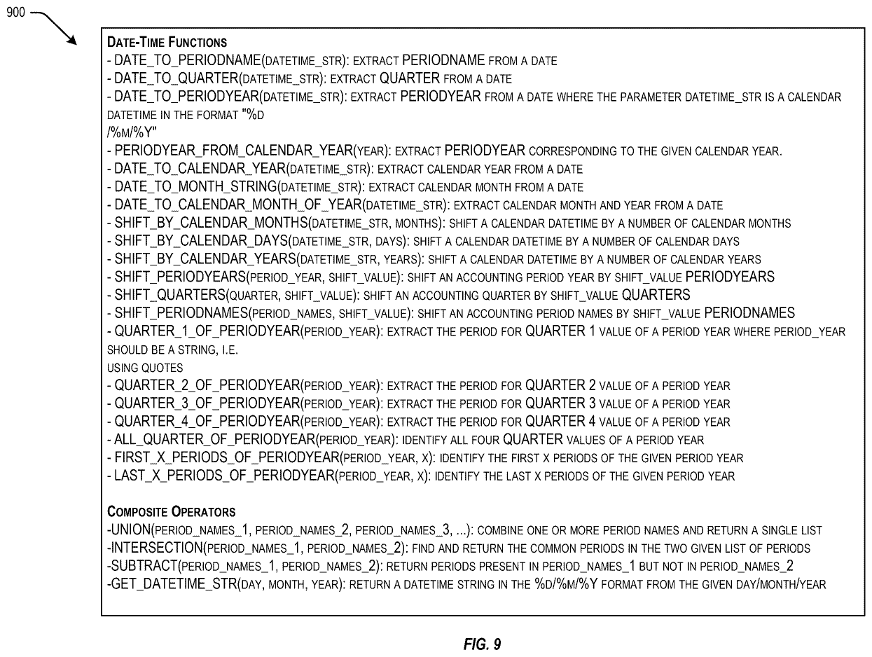

FIG. 9 depicts simplified examples of data time functions and explanations 900 provided to a generative model in a prompt, according to various embodiments. The date-time functions (also referred to as period functions) may be examples of period functions 714 with respect to FIG. 7. The date-time functions as depicted can be populated by a user or automatically generated by a generative model. In a few non-limiting examples, the date time functions may map NL expressions to Gregorian calendar periods and accounting periods, (e.g. “get all accounting periods in June 2024”), translating between Gregorian calendar periods and accounting periods (e.g. “get calendar date corresponding to first accounting period of the year”), navigating a calendar space, (e.g., “shift date by two quarters”), combining accounting periods with set operations, and similar equivalents. Date-time functions can be constructed following the below key principles in the design of functions, their names, and purpose. The date-time functions should be compact. If the number of date-time functions increases, it can hurt the generative model's prediction ability and increase the prompts lengths. Add high level functions to limit verbosity and terseness of gold expressions. In addition, or alternatively, as a number of date-time functions increase, multiple equivalent functional expressions that evaluate to the same final expression are removed and not provided in the prompt. The date-time functions below can be provided in the prompt along with an explanation as to the date-time function. By way of a non-limiting examples, the following date-time functions and explanations can be provided with the prompt:
a) DATE_TO_PERIODNAME(datetime_str): extract PERIODNAME from a date
b) DATE_TO_QUARTER(datetime_str): extract QUARTER from a date
c) DATE_TO_PERIODYEAR(datetime_str): extract PERIODYEAR from a date where the parameter datetime_str is a calendar datetime in the format “% d/% m/% Y”
d) PERIODYEAR_FROM_CALENDAR_YEAR(year): extract PERIODYEAR corresponding to the given calendar year.
e) DATE_TO_CALENDAR_YEAR(datetime_str): extract calendar year from a date
f) DATE_TO_MONTH_STRING(datetime_str): extract calendar month from a date
g) DATE_TO_CALENDAR_MONTH_OF_YEAR(datetime_str): extract calendar month and year from a date
h) SHIFT_BY_CALENDAR_MONTHS(datetime_str, months): shift a calendar datetime by a number of calendar months
i) SHIFT_BY_CALENDAR_DAYS(datetime_str, days): shift a calendar datetime by a number of calendar days
j) SHIFT_BY_CALENDAR_YEARS(datetime_str, years): shift a calendar datetime by a number of calendar years
k) SHIFT_PERIODYEARS(period_year, shift_value): shift an accounting period year by shift_value PERIODYEARS
l) SHIFT_QUARTERS(quarter, shift_value): shift an accounting quarter by shift_value QUARTERS
m) SHIFT_PERIODNAMES(period_names, shift_value): shift an accounting period names by shift_value PERIODNAMES
n) QUARTER_1_OF_PERIODYEAR(period_year): extract the period for QUARTER 1 value of a period year where period_year should be a string, e.g., using quotes
o) QUARTER_2_OF_PERIODYEAR(period_year): extract the period for QUARTER 2 value of a period year
p) QUARTER_3_OF_PERIODYEAR(period_year): extract the period for QUARTER 3 value of a period year
q) QUARTER_4_OF_PERIODYEAR(period_year): extract the period for QUARTER 4 value of a period year
r) ALL_QUARTER_OF_PERIODYEAR(period_year): identify all four QUARTER values of a period year
s) FIRST_X_PERIODS_OF_PERIODYEAR(period_year, x): identify the first x periods of the given period year
t) LAST_X_PERIODS_OF_PERIODYEAR(period_year, x): identify the last x periods of the given period year
u) PERIODNAMES_FOR_FIRST_X_MONTHS_OF_PERIODYEAR(period_year, x): identify the period names corresponding to the first x months of the given period year
v) PERIODNAMES_FOR_LAST_X_MONTHS_OF_PERIODYEAR(period_year, x): identify the period names corresponding to the first x months of the given period year
w) PERIODNAMES_FOR_MONTH_OF_YEAR(month, year): identify all period names of a month of a year specified in month and year
x) PERIODNAMES_FOR_LAST_X_MONTHS(date, X): identify all period names of the current month and X months before the given date
y) PERIODNAMES_FOR_NEXT_X_MONTHS(date, X): identify all period names of the current month and X months after the given date
z) PERIODNAMES_FOR_QTD(today_datetime_str): identify all period names from the start of the current QUARTER to today_datetime_str
aa) PERIODNAMES_FOR_YTD(today_datetime_str): identify all period names from the start of the current PERIODYEAR to today_datetime_str
bb) PERIODNAMES_BETWEEN_DATE_RANGE(start_date, end_date): identify all period names between the calendar period specified by start_date and end_date.
cc) PERIODNAMES_IN_CALENDAR_YEAR(year_str): identify all period names in the calendar year specified by year_str.

In some examples, one or more composite operators (e.g., UNION, INTERSECTION, SUBTRACT, GET_DATETIME_STR, etc.) may be used in conjunction with the date-time functions. The composite operators may be used to combine multiple periods and other date-time functions together. For example: UNION(period_names_1, period_names_2, period_names_3, . . . ): combine one or more period names and return a single list,
INTERSECTION(period_names_1, period_names_2): find and return the common periods in the two given list of periods, SUBTRACT(period_names_1, period_names_2): return periods present in period_names_1 but not in period_names_2, GET_DATETIME_STR (day, month, year): return a datetime string in the % d/% m/% Y format from the given day/month/year. The composite operators can be provided in the prompt along with an instruction such as, but not limited to “You can use the above composite operators to combine multiple periods and other date-time operations”.

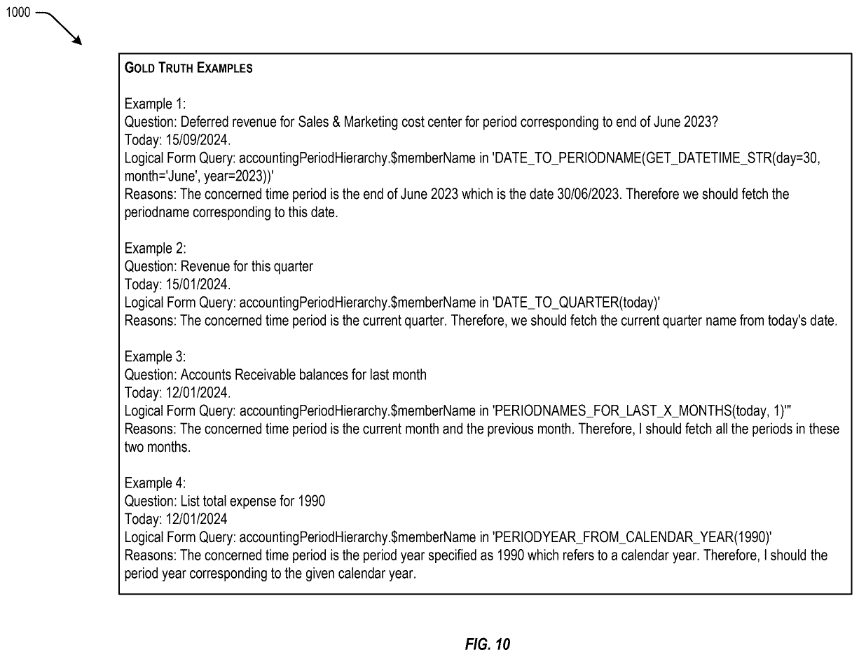

FIG. 10 depicts simplified examples of gold truth examples 1000 provided to a generative model in a prompt, according to various embodiments. The gold truth examples 1000 may be examples of gold truth examples 716 with respect to FIG. 7. The gold truth examples 1000 may serve to help the generative model learn and/or understand a desired output since the gold truth examples 1000 are known to be accurate and are executable on a database. For example, a desired output for a given NL utterance would include a logical form query (sometimes referred to as a filter in the context of BI queries) and reasons why the generative model generated the logical form query. The generative model may leverage the gold truth examples 1000 in view of the task description and date-time functions to generate a logical form query based on a natural language utterance. Some non-limiting examples of gold truth examples are below:

### a) Example 1:

Question: Deferred revenue for Sales & Marketing cost center for period corresponding to end of June 2023?
Today: 15/09/2024.
Logical Form Query: accountingPeriodHierarchy.$memberName in ‘DATE_TO_PERIODNAME(GET_DATETIME_STR(day=30, month=′June’, year=2023))′
Reasons: The concerned time period is the end of June 2023 which is the date 30/06/2023. Therefore we should fetch the periodname corresponding to this date.

### b) Example 2:

Question: Revenue for this quarter
Today: 15/01/2024.
Logical Form Query: accountingPeriodHierarchy.$memberName in
‘DATE_TO_QUARTER(today)’
Reasons: The concerned time period is the current quarter. Therefore, we should fetch the current quarter name from today's date.

### c) Example 3:

Question: Accounts Receivable balances for last month
Today: 12/01/2024.
Logical Form Query: accountingPeriodHierarchy.$memberName in
‘PERIODNAMES_FOR_LAST_X_MONTHS(today, 1)’”
Reasons: The concerned time period is the current month and the previous month.
Therefore, I should fetch all the periods in these two months.

### d) Example 4:

Question: List total expense for 1990
Today: 12/01/2024
Logical Form Query: accountingPeriodHierarchy.$memberName in
‘PERIODYEAR_FROM_CALENDAR_YEAR(1990)’
Reasons: The concerned time period is the period year specified as 1990 which refers to a calendar year. Therefore, I should the period year corresponding to the given calendar year.

### e) Example 5:

Question: List total expense for 1990 and 1985
Today: 12/01/2024
Logical Form Query: accountingPeriodHierarchy.$memberName in
‘UNION(PERIODYEAR_FROM_CALENDAR_YEAR(1990),
PERIODYEAR_FROM_CALENDAR_YEAR(1985))’
Reasons: The concerned time period is the calendar year 1990 and 1985. Therefore, I should fetch all the periods for these calendar years and combine them.

### f) Example 6:

Question″: “Compare total expense this period vs. same period last year”,
Today: 02/05/2010
Logical Form Query: accountingPeriodHierarchy.$memberName in
‘UNION(DATE_TO_PERIODNAME(today),
SHIFT_PERIODYEARS(DATE_TO_PERIODNAME(today),−1))’
Reasons: The concerned time period is the current period and the same period last year. Therefore, we should fetch the current period name from today's date and then shift this period by one period year to get the corresponding period year from last year.

### g) Example 7:

Question″: “Get the account balance on the third of September 2008”,
Today: 02/05/2010
Logical Form Query: accountingPeriodHierarchy.$memberName in ‘DATE_TO_PERIODNAME(GET_DATETIME_STR (day=3, month=′September’, year=2008))′
Reasons: The concerned time period is the given date of third September 2008.
Therefore, we should fetch the corresponding periodname for that date.

### h) Example 8:

Question″: “Get the account balance for the last quarter of 2009”,
Today: 02/05/2010
Logical Form Query: accountingPeriodHierarchy.$memberName in ‘QUARTER_4_OF_PERIODYEAR(PERIODYEAR_FROM_CALENDAR_YEAR(200 9))’
Reasons: The last quarter means the fourth quarter of a period year. We should find the period year corresponding to 2009 and then retrieve the last quarter in it.

### i) Example 9:

Question″: “Balance for the first period of the year”,
Today: 02/05/2010
Logical Form Query: accountingPeriodHierarchy.$memberName in ‘FIRST_X_PERIODS_OF_PERIODYEAR(current_period_year, 1)’
Reasons: This year always means current_period_year. We should always use current_period_year where possible. Then, we should find first period in the current_period_year.

FIG. 11 depicts simplified examples of additional instructions 1100 provided to a generative model in a prompt, according to various embodiments. The additional instructions 1100 may be examples of additional instructions 718 with respect to FIG. 7. The additional instructions 1100 may include specific and/or general instructions to the generative model to promote generation of accurate logical form queries and may be provided in the prompt. By way of non-limiting examples, the additional instructions 1100, may include:
a) If relative period values such as last month or previous quarter is asked, you also need to use information provided in the “Today” field below Question to work on the corresponding period values to check.
b) Financial time periods are not the same as calendar periods, you have to use datetime and account period functions provided above to generate correct period values.
c) If period value information is not mentioned in Question, you need to check for levelName=′PERIODNAME′ AND memberName is equal to the period name of today with DATE_TO_PERIODNAME function.
d) If only the quarter part such Q1 or Qtr4 is mentioned, make sure to use QUARTER_X_OF_PERIODYEAR to get the correct QUARTER period value.
e) “last X months”, e.g. “last 2 months”, make sure to use the PERIODNAMES_FOR_LAST_X_MONTHS function.
f) “QoQ” means the current and the previous quarters.
g) “QuartertoQuarter” means the current and the previous quarters.
h) “Periodtodate” means the current period name.
i) “PTD” means the current period name.
j) “Quartertodate” means “QTD”.
k) “Yeartodate” means “YTD”.
l) “last year end” just means the previous year period, NOT the last period of the previous year.
m) “year” means the period year.
n) Only output the Reasons and Filters.
o) use “today” to mean the current date in the form of dd/mm/yyyy. Do not list out the actual date.
p) use “current_year” to mean the current date in the form of yyyy. Do not list out the actual date.
q) use “current_month” to mean the current month in the form of mm. Do not list out the actual date.
r) use “current_day” to mean the current month in the form of dd. Do not list out the actual date.
s) use “current_weekday” to mean the current day of the week such as Mon, Tue, Wed, Thu, Fri, Sat or Sun. Do not list out the actual date.
t) use “current_period_year” to mean the period year corresponding to today. Do not use DATE_TO_PERIODYEAR(today), or
u) PERIODYEAR_FROM_CALENDAR_YEAR(current_year). Instead use current_period_year in its place.
v) you can only use the list of functions provided above. Do not use any function not provided in the above list.
w) you should use only the “IN” or “NOT IN” operator to compare the returned set of periods.

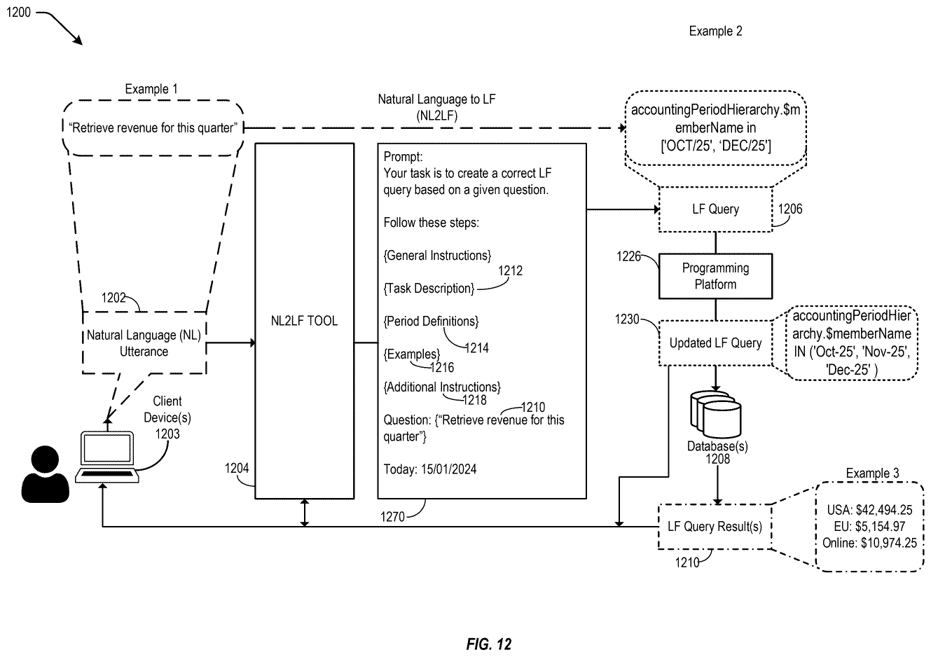

FIG. 12 depicts a simplified diagram for an example natural language to logical form tool transforming a natural language utterance into a logical form with an updated period definition expression. As discussed above and similar to FIG. 5, one or more client device(s) 1203 submits a natural language (NL) utterance 1202 to a component of a NL2LF tool 1204 (e.g., a chatbot). This can happen when a user is accessing a specific website or server requesting information. For example, a user can attempt to pull payable records from an accounting database by chatting (e.g., chat 206) with a chatbot (e.g., SQL agent 202) hosted (or linked) to the website and provide the utterance, “Retrieve revenue for this quarter”.

The NL utterance 1202 is received by one or more NL2SQL tools 1204. To process the question, the NL2LF tool 1204 appends (or otherwise adds) the NL utterance 1202 to a prompt 1270 along with one or more instructions (discussed in more detail with respect to FIG. 6) so that a generative model (e.g., SQL large language model 375) may translate (or otherwise transform) the NL utterance 1202 to a logical form such as LF query 1206. The prompt 1270 includes the NL utterance, as in Example 1, as a section in the prompt 1270 along with a timestamp (e.g., Today 15/01/2024) and several subcomponents (e.g., 1212, 1214, 1216, 1218 which are examples of respective components as discussed in FIGS. 7-11). In some examples, the timestamp may be optional. The NL2LF tool 1204 provides the prompt 1270, which includes the NL utterance 1202 and the subcomponents 1212, 1214, 1216, and/or 1218 in the prompt 1270, to the generative model (not depicted, described in more detail in FIG. 7).

A LF query 1206 may be generated by the generative model based at least in part on the NL utterance 1202 and instructions (e.g., 1212, 1214, 1216, 1218) within the prompt 1270. The LF query 120 (e.g., Example 2) may include a logical form query (e.g., accountingPeriodHierarchy. $memberName in [‘OCT/25’, ‘DEC/25’])) generated by the generative model (not depicted). The LF query 1206 (which is an example of logical form query 722) includes a coded-form expression based at least in part on the NL utterance 1202 which may be extracted or otherwise provided to a programming platform 1226 (as discussed in more detail with respect to FIG. 7) which produces an updated LF query 1230 (which is an example of updated logical form query 730). In this non-limiting example, the updated LF query 1230 is in a correct format for database(s) 1208 (as opposed to FIG. 5 which produced an error) and can be executed on the database(s) 1208 to produce LF query results 1210 (see Example 3). In some examples, the updated LF query 1230 may be provided to the client device(s) 1203 directly, or may be provided in addition to the updated LF query 1230 to the client device(s) 1203. In some examples, explanations (e.g., reasons as in FIG. 10) may be provided with the updated LF query 1230 and/or LF query result(s) 1210 to the client device(s) 1203.

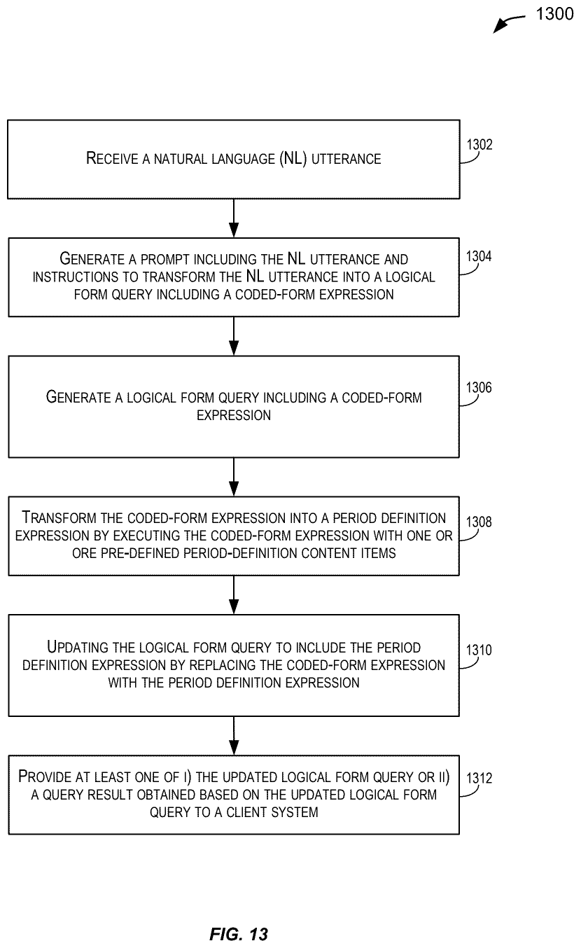

FIG. 13 is a flowchart illustrating an example process for updating a logical form query, according to various embodiments. The processing depicted in FIG. 13 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 13 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-12, the processing depicted in FIG. 13 may be performed by a NL2SQL tool and/or a NL2LF tool, as described with respect to FIGS. 1-12.

At 1302, a natural language (NL) utterance may be received. The NL utterance (e.g., NL utterance 702, Example 1 in FIG. 7, etc.) may be received by a NL2LF tool which provides the NL utterance to a generative model. In some examples, the NL utterance may be transformed into a different format prior to providing the NL utterance to the generative model or the NL utterance may be transformed into a new version by the generative model prior to generating the coded-form expression at 1306.

At 1304, a prompt (e.g., prompt 706 with respect to FIG. 7) may be generated (e.g., by generative model 720) including the NL utterance and instructions to transform the NL utterance into a logical form query (e.g., logical form query 722 with respect to FIG. 7) including a coded-form expression (e.g., coded-form expression 724), wherein the coded-form expression is an executable programming language function that is independent of at least one period definition expression. In some examples, the instructions include a task description describing one or more time periods (e.g., as in FIG. 8), one or more period functions (e.g., as in FIG. 9) sharing a programming language format with the coded-form expression, one or more gold truth examples (e.g., as in FIG. 10) including at least one gold truth logical form query, wherein each gold truth logical form query includes a gold truth coded-form expression, and one or more additional instructions (e.g., FIG. 11) which provide context to the generative model relating to the task description, the one or more period functions, or the one or more gold truth examples.

At 1306, a logical form query may be generated including a coded-form expression. In some examples, generating the logical form query includes generating, by the generative model, a first coded-form expression (e.g., DATE_TO_PERIODNAME(today)) associated with a first portion of the NL utterance (e.g., “this period” in “Compare total expense this period vs. same period last year”). The first portion may include a first time period, and generating, by the generative model, a second coded-form expression (e.g., SHIFT_PERIODYEARS(DATE_TO_PERIODNAME(today), −1)) associated with a second portion (e.g., “same period last year” in “Compare total expense this period vs. same period last year”) of the NL utterance, wherein the second portion includes a second time period different from the first time period, and wherein the coded-form expression comprises the first coded-form expression and the second coded-form expression, and generating, by the generative model, one or more composite operators (e.g., “UNION” as in FIG. 9) associated with a programming language that the coded-form expression is formatted in, wherein the one or more composite operators operate on the first coded-form expression and the second coded-form expression to generate a composite coded-form expression (e.g., UNION(DATE_TO_PERIODNAME(today), SHIFT_PERIODYEARS(DATE_TO_PERIODNAME(today), −1))).

At 1308, the coded-form expression may be transformed into a period definition expression by executing the coded-form expression with one or more pre-defined period-definition content items. In some examples, transforming the coded-form expression into the period definition expression (e.g., ‘[‘Jan.-24’, ‘Feb.-24’, ‘Mar.-24’, ‘Apr.-24’, ‘May-24’, ‘Jan.-25’, ‘Feb.-25’, ‘Mar.-25’, ‘Apr.-25’, ‘May-25’]’), is based on the composite coded-form expression

At 1310, the logical form query may be updated to include the period definition expression by replacing, transforming, or updating the coded-form expression with the period definition expressions.

At 1312, at least one of i) the updated logical form query or ii) a query result obtained based on the updated logical form query may be provided to a client system. In some examples, prior to providing the query result to the client system, the computer-implemented method further includes executing the updated logical form query on a query database to obtain the query result. In addition, or alternatively, one or more explanations associated with the updated logical form query may be generated by the generative model (or a separate generative model), and provide the one or more explanations to the client system.

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### Illustrative Systems

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration content items (e.g., files). Thus, the overall topology of the infrastructure (e.g., what resources depend on which, and how they each work together) can be described declaratively. In some instances, once the topology is defined, a workflow can be generated that creates and/or manages the different components described in the configuration content items.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

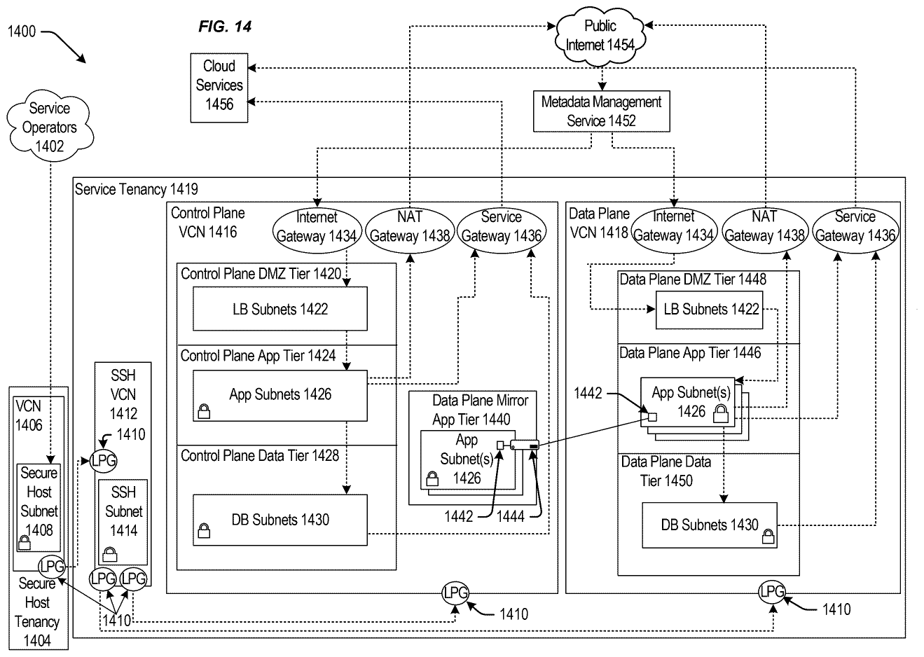

FIG. 14 is a block diagram 1400 illustrating an example pattern of an IaaS architecture, according to at least one embodiment. Service operators 1402 can be communicatively coupled to a secure host tenancy 1404 that can include a virtual cloud network (VCN) 1406 and a secure host subnet 1408. In some examples, the service operators 1402 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1406 and/or the Internet.

The VCN 1406 can include a local peering gateway (LPG) 1410 that can be communicatively coupled to a secure shell (SSH) VCN 1412 via an LPG 1410 contained in the SSH VCN 1412. The SSH VCN 1412 can include an SSH subnet 1414, and the SSH VCN 1412 can be communicatively coupled to a control plane VCN 1416 via the LPG 1410 contained in the control plane VCN 1416. Also, the SSH VCN 1412 can be communicatively coupled to a data plane VCN 1418 via an LPG 1410. The control plane VCN 1416 and the data plane VCN 1418 can be contained in a service tenancy 1419 that can be owned and/or operated by the IaaS provider.

The control plane VCN 1416 can include a control plane demilitarized zone (DMZ) tier 1420 that acts as a perimeter network (e.g., portions of a corporate network between the corporate intranet and external networks). The DMZ-based servers may have restricted responsibilities and help keep breaches contained. Additionally, the DMZ tier 1420 can include one or more load balancer (LB) subnet(s) 1422, a control plane app tier 1424 that can include app subnet(s) 1426, a control plane data tier 1428 that can include database (DB) subnet(s) 1430 (e.g., frontend DB subnet(s) and/or backend DB subnet(s)). The LB subnet(s) 1422 contained in the control plane DMZ tier 1420 can be communicatively coupled to the app subnet(s) 1426 contained in the control plane app tier 1424 and an Internet gateway 1434 that can be contained in the control plane VCN 1416, and the app subnet(s) 1426 can be communicatively coupled to the DB subnet(s) 1430 contained in the control plane data tier 1428 and a service gateway 1436 and a network address translation (NAT) gateway 1438. The control plane VCN 1416 can include the service gateway 1436 and the NAT gateway 1438.

The control plane VCN 1416 can include a data plane mirror app tier 1440 that can include app subnet(s) 1426. The app subnet(s) 1426 contained in the data plane mirror app tier 1440 can include a virtual network interface controller (VNIC) 1442 that can execute a compute instance 1444. The compute instance 1444 can communicatively couple the app subnet(s) 1426 of the data plane mirror app tier 1440 to app subnet(s) 1426 that can be contained in a data plane app tier 1446.

The data plane VCN 1418 can include the data plane app tier 1446, a data plane DMZ tier 1448, and a data plane data tier 1450. The data plane DMZ tier 1448 can include LB subnet(s) 1422 that can be communicatively coupled to the app subnet(s) 1426 of the data plane app tier 1446 and the Internet gateway 1434 of the data plane VCN 1418. The app subnet(s) 1426 can be communicatively coupled to the service gateway 1436 of the data plane VCN 1418 and the NAT gateway 1438 of the data plane VCN 1418. The data plane data tier 1450 can also include the DB subnet(s) 1430 that can be communicatively coupled to the app subnet(s) 1426 of the data plane app tier 1446.

The Internet gateway 1434 of the control plane VCN 1416 and of the data plane VCN 1418 can be communicatively coupled to a metadata management service 1452 that can be communicatively coupled to public Internet 1454. Public Internet 1454 can be communicatively coupled to the NAT gateway 1438 of the control plane VCN 1416 and of the data plane VCN 1418. The service gateway 1436 of the control plane VCN 1416 and of the data plane VCN 1418 can be communicatively coupled to cloud services 1456.

In some examples, the service gateway 1436 of the control plane VCN 1416 or of the data plane VCN 1418 can make application programming interface (API) calls to cloud services 1456 without going through public Internet 1454. The API calls to cloud services 1456 from the service gateway 1436 can be one-way: the service gateway 1436 can make API calls to cloud services 1456, and cloud services 1456 can send requested data to the service gateway 1436. But, cloud services 1456 may not initiate API calls to the service gateway 1436.

In some examples, the secure host tenancy 1404 can be directly connected to the service tenancy 1419, which may be otherwise isolated. The secure host subnet 1408 can communicate with the SSH subnet 1414 through an LPG 1410 that may enable two-way communication over an otherwise isolated system. Connecting the secure host subnet 1408 to the SSH subnet 1414 may give the secure host subnet 1408 access to other entities within the service tenancy 1419.

The control plane VCN 1416 may allow users of the service tenancy 1419 to set up or otherwise provision desired resources. Desired resources provisioned in the control plane VCN 1416 may be deployed or otherwise used in the data plane VCN 1418. In some examples, the control plane VCN 1416 can be isolated from the data plane VCN 1418, and the data plane mirror app tier 1440 of the control plane VCN 1416 can communicate with the data plane app tier 1446 of the data plane VCN 1418 via VNICs 1442 that can be contained in the data plane mirror app tier 1440 and the data plane app tier 1446.

In some examples, users of the system, or customers, can make requests, for example create, read, update, or delete (CRUD) operations, through public Internet 1454 that can communicate the requests to the metadata management service 1452. The metadata management service 1452 can communicate the request to the control plane VCN 1416 through the Internet gateway 1434. The request can be received by the LB subnet(s) 1422 contained in the control plane DMZ tier 1420. The LB subnet(s) 1422 may determine that the request is valid, and in response to this determination, the LB subnet(s) 1422 can transmit the request to app subnet(s) 1426 contained in the control plane app tier 1424. If the request is validated and requires a call to public Internet 1454, the call to public Internet 1454 may be transmitted to the NAT gateway 1438 that can make the call to public Internet 1454. Metadata that may be desired to be stored by the request can be stored in the DB subnet(s) 1430.

In some examples, the data plane mirror app tier 1440 can facilitate direct communication between the control plane VCN 1416 and the data plane VCN 1418. For example, changes, updates, or other suitable modifications to configuration may be desired to be applied to the resources contained in the data plane VCN 1418. Via a VNIC 1442, the control plane VCN 1416 can directly communicate with, and can thereby execute the changes, updates, or other suitable modifications to configuration to, resources contained in the data plane VCN 1418.

In some embodiments, the control plane VCN 1416 and the data plane VCN 1418 can be contained in the service tenancy 1419. In this case, the user, or the customer, of the system may not own or operate either the control plane VCN 1416 or the data plane VCN 1418. Instead, the IaaS provider may own or operate the control plane VCN 1416 and the data plane VCN 1418, both of which may be contained in the service tenancy 1419. This embodiment can enable isolation of networks that may prevent users or customers from interacting with other users', or other customers', resources. Also, this embodiment may allow users or customers of the system to store databases privately without needing to rely on public Internet 1454, which may not have a desired level of threat prevention, for storage.

In other embodiments, the LB subnet(s) 1422 contained in the control plane VCN 1416 can be configured to receive a signal from the service gateway 1436. In this embodiment, the control plane VCN 1416 and the data plane VCN 1418 may be configured to be called by a customer of the IaaS provider without calling public Internet 1454. Customers of the IaaS provider may desire this embodiment since database(s) that the customers use may be controlled by the IaaS provider and may be stored on the service tenancy 1419, which may be isolated from public Internet 1454.

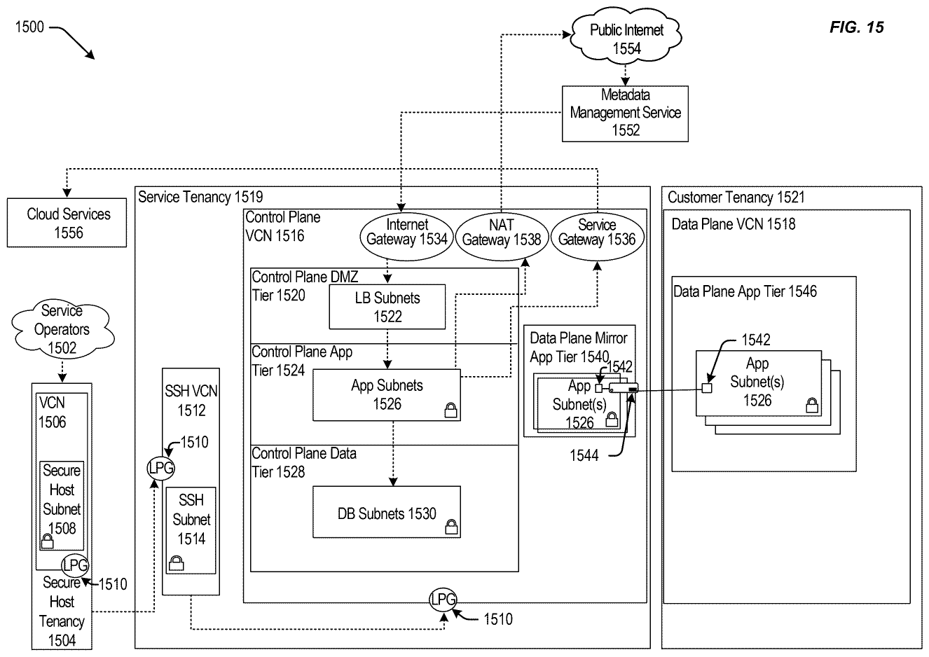

FIG. 15 is a block diagram 1500 illustrating another example pattern of an IaaS architecture, according to at least one embodiment. Service operators 1502 (e.g., service operators 1402 of FIG. 14) can be communicatively coupled to a secure host tenancy 1504 (e.g., the secure host tenancy 1404 of FIG. 14) that can include a virtual cloud network (VCN) 1506 (e.g., the VCN 1406 of FIG. 14) and a secure host subnet 1508 (e.g., the secure host subnet 1408 of FIG. 14). The VCN 1506 can include a local peering gateway (LPG) 1510 (e.g., the LPG 1410 of FIG. 14) that can be communicatively coupled to a secure shell (SSH) VCN 1512 (e.g., the SSH VCN 1412 of FIG. 14) via an LPG 1410 contained in the SSH VCN 1512. The SSH VCN 1512 can include an SSH subnet 1514 (e.g., the SSH subnet 1414 of FIG. 14), and the SSH VCN 1512 can be communicatively coupled to a control plane VCN 1516 (e.g., the control plane VCN 1416 of FIG. 14) via an LPG 1510 contained in the control plane VCN 1516. The control plane VCN 1516 can be contained in a service tenancy 1519 (e.g., the service tenancy 1419 of FIG. 14), and the data plane VCN 1518 (e.g., the data plane VCN 1418 of FIG. 14) can be contained in a customer tenancy 1521 that may be owned or operated by users, or customers, of the system.

The control plane VCN 1516 can include a control plane DMZ tier 1520 (e.g., the control plane DMZ tier 1420 of FIG. 14) that can include LB subnet(s) 1522 (e.g., LB subnet(s) 1422 of FIG. 14), a control plane app tier 1524 (e.g., the control plane app tier 1424 of FIG. 14) that can include app subnet(s) 1526 (e.g., app subnet(s) 1426 of FIG. 14), a control plane data tier 1528 (e.g., the control plane data tier 1428 of FIG. 14) that can include database (DB) subnet(s) 1530 (e.g., similar to DB subnet(s) 1430 of FIG. 14). The LB subnet(s) 1522 contained in the control plane DMZ tier 1520 can be communicatively coupled to the app subnet(s) 1526 contained in the control plane app tier 1524 and an Internet gateway 1534 (e.g., the Internet gateway 1434 of FIG. 14) that can be contained in the control plane VCN 1516, and the app subnet(s) 1526 can be communicatively coupled to the DB subnet(s) 1530 contained in the control plane data tier 1528 and a service gateway 1536 (e.g., the service gateway 1436 of FIG. 14) and a network address translation (NAT) gateway 1538 (e.g., the NAT gateway 1438 of FIG. 14). The control plane VCN 1516 can include the service gateway 1536 and the NAT gateway 1538.

The control plane VCN 1516 can include a data plane mirror app tier 1540 (e.g., the data plane mirror app tier 1440 of FIG. 14) that can include app subnet(s) 1526. The app subnet(s) 1526 contained in the data plane mirror app tier 1540 can include a virtual network interface controller (VNIC) 1542 (e.g., the VNIC of 1442) that can execute a compute instance 1544 (e.g., similar to the compute instance 1444 of FIG. 14). The compute instance 1544 can facilitate communication between the app subnet(s) 1526 of the data plane mirror app tier 1540 and the app subnet(s) 1526 that can be contained in a data plane app tier 1546 (e.g., the data plane app tier 1446 of FIG. 14) via the VNIC 1542 contained in the data plane mirror app tier 1540 and the VNIC 1542 contained in the data plane app tier 1546.

The Internet gateway 1534 contained in the control plane VCN 1516 can be communicatively coupled to a metadata management service 1552 (e.g., the metadata management service 1452 of FIG. 14) that can be communicatively coupled to public Internet 1554 (e.g., public Internet 1454 of FIG. 14). Public Internet 1554 can be communicatively coupled to the NAT gateway 1538 contained in the control plane VCN 1516. The service gateway 1536 contained in the control plane VCN 1516 can be communicatively coupled to cloud services 1556 (e.g., cloud services 1456 of FIG. 14).

In some examples, the data plane VCN 1518 can be contained in the customer tenancy 1521. In this case, the IaaS provider may provide the control plane VCN 1516 for each customer, and the IaaS provider may, for each customer, set up a unique compute instance 1544 that is contained in the service tenancy 1519. Each compute instance 1544 may allow communication between the control plane VCN 1516, contained in the service tenancy 1519, and the data plane VCN 1518 that is contained in the customer tenancy 1521. The compute instance 1544 may allow resources, that are provisioned in the control plane VCN 1516 that is contained in the service tenancy 1519, to be deployed or otherwise used in the data plane VCN 1518 that is contained in the customer tenancy 1521.

In other examples, the customer of the IaaS provider may have databases that live in the customer tenancy 1521. In this example, the control plane VCN 1516 can include the data plane mirror app tier 1540 that can include app subnet(s) 1526. The data plane mirror app tier 1540 can reside in the data plane VCN 1518, but the data plane mirror app tier 1540 may not live in the data plane VCN 1518. That is, the data plane mirror app tier 1540 may have access to the customer tenancy 1521, but the data plane mirror app tier 1540 may not exist in the data plane VCN 1518 or be owned or operated by the customer of the IaaS provider. The data plane mirror app tier 1540 may be configured to make calls to the data plane VCN 1518 but may not be configured to make calls to any entity contained in the control plane VCN 1516. The customer may desire to deploy or otherwise use resources in the data plane VCN 1518 that are provisioned in the control plane VCN 1516, and the data plane mirror app tier 1540 can facilitate the desired deployment, or other usage of resources, of the customer.

In some embodiments, the customer of the IaaS provider can apply filters to the data plane VCN 1518. In this embodiment, the customer can determine what the data plane VCN 1518 can access, and the customer may restrict access to public Internet 1554 from the data plane VCN 1518. The IaaS provider may not be able to apply filters or otherwise control access of the data plane VCN 1518 to any outside networks or databases. Applying filters and controls by the customer onto the data plane VCN 1518, contained in the customer tenancy 1521, can help isolate the data plane VCN 1518 from other customers and from public Internet 1554.

In some embodiments, cloud services 1556 can be called by the service gateway 1536 to access services that may not exist on public Internet 1554, on the control plane VCN 1516, or on the data plane VCN 1518. The connection between cloud services 1556 and the control plane VCN 1516 or the data plane VCN 1518 may not be live or continuous. Cloud services 1556 may exist on a different network owned or operated by the IaaS provider. Cloud services 1556 may be configured to receive calls from the service gateway 1536 and may be configured to not receive calls from public Internet 1554. Some cloud services 1556 may be isolated from other cloud services 1556, and the control plane VCN 1516 may be isolated from cloud services 1556 that may not be in the same region as the control plane VCN 1516. For example, the control plane VCN 1516 may be located in “Region 1,” and cloud service “Deployment 14,” may be located in Region 1 and in “Region 2.” If a call to Deployment 14 is made by the service gateway 1536 contained in the control plane VCN 1516 located in Region 1, the call may be transmitted to Deployment 14 in Region 1. In this example, the control plane VCN 1516, or Deployment 14 in Region 1, may not be communicatively coupled to, or otherwise in communication with, Deployment 14 in Region 2.

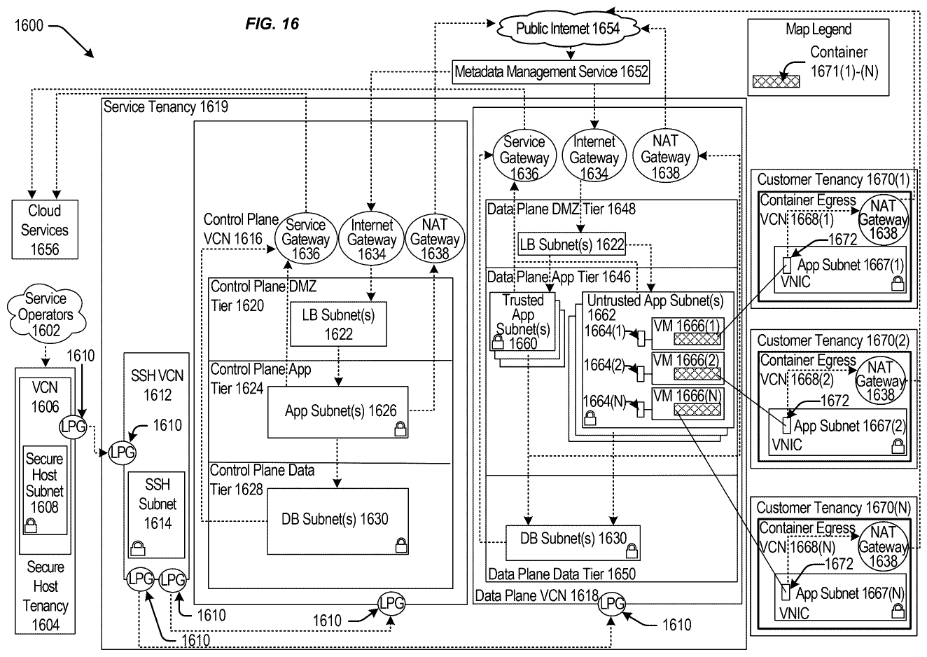

FIG. 16 is a block diagram 1600 illustrating another example pattern of an IaaS architecture, according to at least one embodiment. Service operators 1602 (e.g., service operators 1402 of FIG. 14) can be communicatively coupled to a secure host tenancy 1604 (e.g., the secure host tenancy 1404 of FIG. 14) that can include a virtual cloud network (VCN) 1606 (e.g., the VCN 1406 of FIG. 14) and a secure host subnet 1608 (e.g., the secure host subnet 1408 of FIG. 14). The VCN 1606 can include an LPG 1610 (e.g., the LPG 1410 of FIG. 14) that can be communicatively coupled to an SSH VCN 1612 (e.g., the SSH VCN 1412 of FIG. 14) via an LPG 1610 contained in the SSH VCN 1612. The SSH VCN 1612 can include an SSH subnet 1614 (e.g., the SSH subnet 1414 of FIG. 14), and the SSH VCN 1612 can be communicatively coupled to a control plane VCN 1616 (e.g., the control plane VCN 1416 of FIG. 14) via an LPG 1610 contained in the control plane VCN 1616 and to a data plane VCN 1618 (e.g., the data plane 1418 of FIG. 14) via an LPG 1610 contained in the data plane VCN 1618. The control plane VCN 1616 and the data plane VCN 1618 can be contained in a service tenancy 1619 (e.g., the service tenancy 1419 of FIG. 14).

The control plane VCN 1616 can include a control plane DMZ tier 1620 (e.g., the control plane DMZ tier 1420 of FIG. 14) that can include load balancer (LB) subnet(s) 1622 (e.g., LB subnet(s) 1422 of FIG. 14), a control plane app tier 1624 (e.g., the control plane app tier 1424 of FIG. 14) that can include app subnet(s) 1626 (e.g., similar to app subnet(s) 1426 of FIG. 14), a control plane data tier 1628 (e.g., the control plane data tier 1428 of FIG. 14) that can include DB subnet(s) 1630. The LB subnet(s) 1622 contained in the control plane DMZ tier 1620 can be communicatively coupled to the app subnet(s) 1626 contained in the control plane app tier 1624 and to an Internet gateway 1634 (e.g., the Internet gateway 1434 of FIG. 14) that can be contained in the control plane VCN 1616, and the app subnet(s) 1626 can be communicatively coupled to the DB subnet(s) 1630 contained in the control plane data tier 1628 and to a service gateway 1636 (e.g., the service gateway of FIG. 14) and a network address translation (NAT) gateway 1638 (e.g., the NAT gateway 1438 of FIG. 14). The control plane VCN 1616 can include the service gateway 1636 and the NAT gateway 1638.

The data plane VCN 1618 can include a data plane app tier 1646 (e.g., the data plane app tier 1446 of FIG. 14), a data plane DMZ tier 1648 (e.g., the data plane DMZ tier 1448 of FIG. 14), and a data plane data tier 1650 (e.g., the data plane data tier 1450 of FIG. 14). The data plane DMZ tier 1648 can include LB subnet(s) 1622 that can be communicatively coupled to trusted app subnet(s) 1660 and untrusted app subnet(s) 1662 of the data plane app tier 1646 and the Internet gateway 1634 contained in the data plane VCN 1618. The trusted app subnet(s) 1660 can be communicatively coupled to the service gateway 1636 contained in the data plane VCN 1618, the NAT gateway 1638 contained in the data plane VCN 1618, and DB subnet(s) 1630 contained in the data plane data tier 1650. The untrusted app subnet(s) 1662 can be communicatively coupled to the service gateway 1636 contained in the data plane VCN 1618 and DB subnet(s) 1630 contained in the data plane data tier 1650. The data plane data tier 1650 can include DB subnet(s) 1630 that can be communicatively coupled to the service gateway 1636 contained in the data plane VCN 1618.

The untrusted app subnet(s) 1662 can include one or more primary VNICs 1664(1)-(N) that can be communicatively coupled to tenant virtual machines (VMs) 1666(1)-(N). Each tenant VM 1666(1)-(N) can be communicatively coupled to a respective app subnet 1667(1)-(N) that can be contained in respective container egress VCNs 1668(1)-(N) that can be contained in respective customer tenancies 1670(1)-(N). Respective secondary VNICs 1672(1)-(N) can facilitate communication between the untrusted app subnet(s) 1662 contained in the data plane VCN 1618 and the app subnet contained in the container egress VCNs 1668(1)-(N). Each container egress VCNs 1668(1)-(N) can include a NAT gateway 1638 that can be communicatively coupled to public Internet 1654 (e.g., public Internet 1454 of FIG. 14).

The Internet gateway 1634 contained in the control plane VCN 1616 and contained in the data plane VCN 1618 can be communicatively coupled to a metadata management service 1652 (e.g., the metadata management system 1452 of FIG. 14) that can be communicatively coupled to public Internet 1654. Public Internet 1654 can be communicatively coupled to the NAT gateway 1638 contained in the control plane VCN 1616 and contained in the data plane VCN 1618. The service gateway 1636 contained in the control plane VCN 1616 and contained in the data plane VCN 1618 can be communicatively coupled to cloud services 1656.

In some embodiments, the data plane VCN 1618 can be integrated with customer tenancies 1670. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1646. Code to run the function may be executed in the VMs 1666(1)-(N), and the code may not be configured to run anywhere else on the data plane VCN 1618. Each VM 1666(1)-(N) may be connected to one customer tenancy 1670. Respective containers 1671(1)-(N) contained in the VMs 1666(1)-(N) may be configured to run the code. In this case, there can be a dual isolation (e.g., the containers 1671(1)-(N) running code, where the containers 1671(1)-(N) may be contained in at least the VM 1666(1)-(N) that are contained in the untrusted app subnet(s) 1662), which may help prevent incorrect or otherwise undesirable code from damaging the network of the IaaS provider or from damaging a network of a different customer. The containers 1671(1)-(N) may be communicatively coupled to the customer tenancy 1670 and may be configured to transmit or receive data from the customer tenancy 1670. The containers 1671(1)-(N) may not be configured to transmit or receive data from any other entity in the data plane VCN 1618. Upon completion of running the code, the IaaS provider may kill or otherwise dispose of the containers 1671(1)-(N).

In some embodiments, the trusted app subnet(s) 1660 may run code that may be owned or operated by the IaaS provider. In this embodiment, the trusted app subnet(s) 1660 may be communicatively coupled to the DB subnet(s) 1630 and be configured to execute CRUD operations in the DB subnet(s) 1630. The untrusted app subnet(s) 1662 may be communicatively coupled to the DB subnet(s) 1630, but in this embodiment, the untrusted app subnet(s) may be configured to execute read operations in the DB subnet(s) 1630. The containers 1671(1)-(N) that can be contained in the VM 1666(1)-(N) of each customer and that may run code from the customer may not be communicatively coupled with the DB subnet(s) 1630.

In other embodiments, the control plane VCN 1616 and the data plane VCN 1618 may not be directly communicatively coupled. In this embodiment, there may be no direct communication between the control plane VCN 1616 and the data plane VCN 1618. However, communication can occur indirectly through at least one method. An LPG 1610 may be established by the IaaS provider that can facilitate communication between the control plane VCN 1616 and the data plane VCN 1618. In another example, the control plane VCN 1616 or the data plane VCN 1618 can make a call to cloud services 1656 via the service gateway 1636. For example, a call to cloud services 1656 from the control plane VCN 1616 can include a request for a service that can communicate with the data plane VCN 1618.

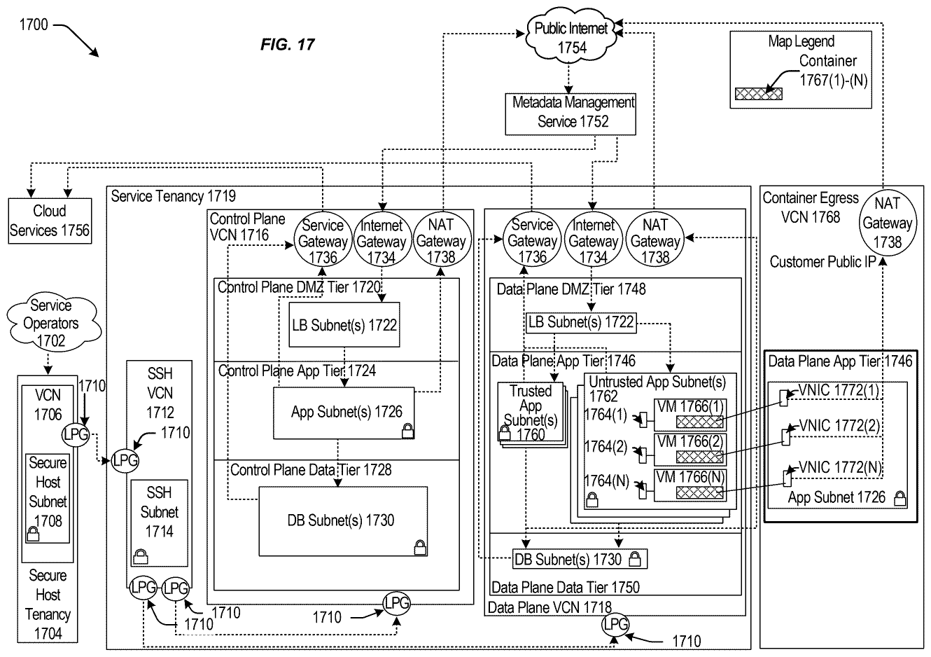

FIG. 17 is a block diagram 1700 illustrating another example pattern of an IaaS architecture, according to at least one embodiment. Service operators 1702 (e.g., service operators 1402 of FIG. 14) can be communicatively coupled to a secure host tenancy 1704 (e.g., the secure host tenancy 1404 of FIG. 14) that can include a virtual cloud network (VCN) 1706 (e.g., the VCN 1406 of FIG. 14) and a secure host subnet 1708 (e.g., the secure host subnet 1408 of FIG. 14). The VCN 1706 can include an LPG 1710 (e.g., the LPG 1410 of FIG. 14) that can be communicatively coupled to an SSH VCN 1712 (e.g., the SSH VCN 1412 of FIG. 14) via an LPG 1710 contained in the SSH VCN 1712. The SSH VCN 1712 can include an SSH subnet 1714 (e.g., the SSH subnet 1414 of FIG. 14), and the SSH VCN 1712 can be communicatively coupled to a control plane VCN 1716 (e.g., the control plane VCN 1416 of FIG. 14) via an LPG 1710 contained in the control plane VCN 1716 and to a data plane VCN 1718 (e.g., the data plane 1418 of FIG. 14) via an LPG 1710 contained in the data plane VCN 1718. The control plane VCN 1716 and the data plane VCN 1718 can be contained in a service tenancy 1719 (e.g., the service tenancy 1419 of FIG. 14).

The control plane VCN 1716 can include a control plane DMZ tier 1720 (e.g., the control plane DMZ tier 1420 of FIG. 14) that can include LB subnet(s) 1722 (e.g., LB subnet(s) 1422 of FIG. 14), a control plane app tier 1724 (e.g., the control plane app tier 1424 of FIG. 14) that can include app subnet(s) 1726 (e.g., app subnet(s) 1426 of FIG. 14), a control plane data tier 1728 (e.g., the control plane data tier 1428 of FIG. 14) that can include DB subnet(s) 1730 (e.g., DB subnet(s) 1630 of FIG. 16). The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1434 of FIG. 14) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 14) and a network address translation (NAT) gateway 1738 (e.g., the NAT gateway 1438 of FIG. 14). The control plane VCN 1716 can include the service gateway 1736 and the NAT gateway 1738.

The data plane VCN 1718 can include a data plane app tier 1746 (e.g., the data plane app tier 1446 of FIG. 14), a data plane DMZ tier 1748 (e.g., the data plane DMZ tier 1448 of FIG. 14), and a data plane data tier 1750 (e.g., the data plane data tier 1450 of FIG. 14). The data plane DMZ tier 1748 can include LB subnet(s) 1722 that can be communicatively coupled to trusted app subnet(s) 1760 (e.g., trusted app subnet(s) 1660 of FIG. 16) and untrusted app subnet(s) 1762 (e.g., untrusted app subnet(s) 1662 of FIG. 16) of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include primary VNICs 1764(1)-(N) that can be communicatively coupled to tenant virtual machines (VMs) 1766(1)-(N) residing within the untrusted app subnet(s) 1762. Each tenant VM 1766(1)-(N) can run code in a respective container 1767(1)-(N), and be communicatively coupled to an app subnet 1726 that can be contained in a data plane app tier 1746 that can be contained in a container egress VCN 1768. Respective secondary VNICs 1772(1)-(N) can facilitate communication between the untrusted app subnet(s) 1762 contained in the data plane VCN 1718 and the app subnet contained in the container egress VCN 1768. The container egress VCN can include a NAT gateway 1738 that can be communicatively coupled to public Internet 1754 (e.g., public Internet 1454 of FIG. 14).

The Internet gateway 1734 contained in the control plane VCN 1716 and contained in the data plane VCN 1718 can be communicatively coupled to a metadata management service 1752 (e.g., the metadata management system 1452 of FIG. 14) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively coupled to cloud services 1756.

In some examples, the pattern illustrated by the architecture of block diagram 1700 of FIG. 17 may be considered an exception to the pattern illustrated by the architecture of block diagram 1600 of FIG. 16 and may be desirable for a customer of the IaaS provider if the IaaS provider cannot directly communicate with the customer (e.g., a disconnected region). The respective containers 1767(1)-(N) that are contained in the VMs 1766(1)-(N) for each customer can be accessed in real-time by the customer. The containers 1767(1)-(N) may be configured to make calls to respective secondary VNICs 1772(1)-(N) contained in app subnet(s) 1726 of the data plane app tier 1746 that can be contained in the container egress VCN 1768. The secondary VNICs 1772(1)-(N) can transmit the calls to the NAT gateway 1738 that may transmit the calls to public Internet 1754. In this example, the containers 1767(1)-(N) that can be accessed in real-time by the customer can be isolated from the control plane VCN 1716 and can be isolated from other entities contained in the data plane VCN 1718. The containers 1767(1)-(N) may also be isolated from resources from other customers.

In other examples, the customer can use the containers 1767(1)-(N) to call cloud services 1756. In this example, the customer may run code in the containers 1767(1)-(N) that requests a service from cloud services 1756. The containers 1767(1)-(N) can transmit this request to the secondary VNICs 1772(1)-(N) that can transmit the request to the NAT gateway that can transmit the request to public Internet 1754. Public Internet 1754 can transmit the request to LB subnet(s) 1722 contained in the control plane VCN 1716 via the Internet gateway 1734. In response to determining the request is valid, the LB subnet(s) can transmit the request to app subnet(s) 1726 that can transmit the request to cloud services 1756 via the service gateway 1736.

It should be appreciated that IaaS architectures 1400, 1500, 1600, 1700 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

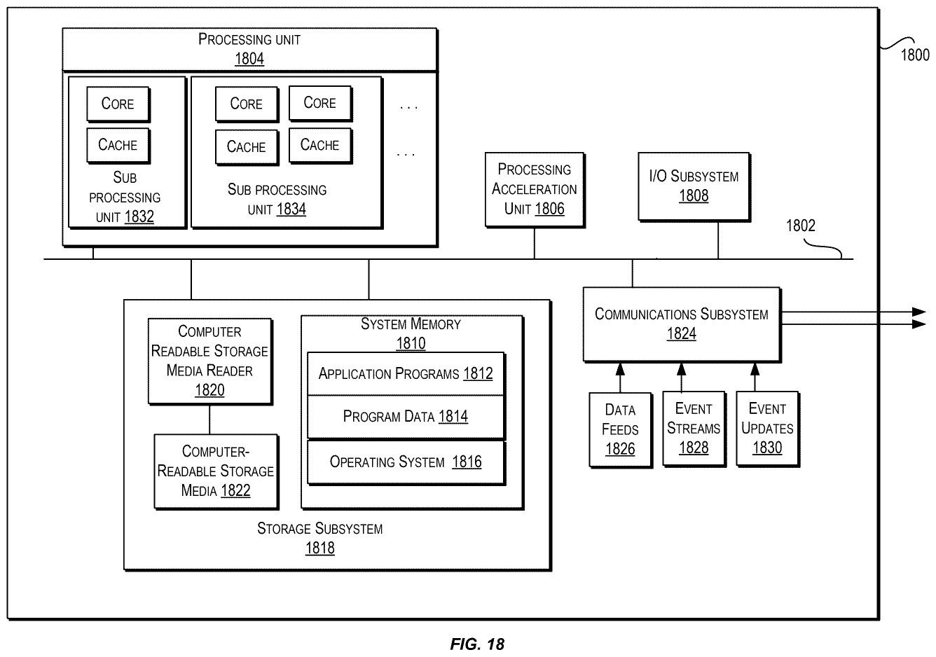

FIG. 18 illustrates an example computer system 1800, in which various embodiments may be implemented. The system 1800 may be used to implement any of the computer systems described above. As shown in the figure, computer system 1800 includes a processing unit 1804 that communicates with a number of peripheral subsystems via a bus subsystem 1802. These peripheral subsystems may include a processing acceleration unit 1806, an I/O subsystem 1808, a storage subsystem 1818 and a communications subsystem 1824. Storage subsystem 1818 includes tangible computer-readable storage media 1822 and a system memory 1810.

Bus subsystem 1802 provides a mechanism for letting the various components and subsystems of computer system 1800 communicate with each other as intended. Although bus subsystem 1802 is shown schematically as a single bus, alternative embodiments of the bus subsystem may utilize multiple buses. Bus subsystem 1802 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1804, which can be implemented as one or more integrated circuits (e.g., a conventional microprocessor or microcontroller), controls the operation of computer system 1800. One or more processors may be included in processing unit 1804. These processors may include single core or multicore processors. In certain embodiments, processing unit 1804 may be implemented as one or more independent processing units 1832 and/or 1834 with single or multicore processors included in each processing unit. In other embodiments, processing unit 1804 may also be implemented as a quad-core processing unit formed by integrating two dual-core processors into a single chip.

In various embodiments, processing unit 1804 can execute a variety of programs in response to program code and can maintain multiple concurrently executing programs or processes. At any given time, some or all of the program code to be executed can be resident in processor(s) 1804 and/or in storage subsystem 1818. Through suitable programming, processor(s) 1804 can provide various functionalities described above. Computer system 1800 may additionally include a processing acceleration unit 1806, which can include a digital signal processor (DSP), a special-purpose processor, and/or the like.

I/O subsystem 1808 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1800 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1800 may comprise a storage subsystem 1818 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1804 provide the functionality described above. Storage subsystem 1818 may also provide a repository for storing data used in accordance with the present disclosure.

As depicted in the example in FIG. 18, storage subsystem 1818 can include various components including a system memory 1810, computer-readable storage media 1822, and a computer readable storage media reader 1820. System memory 1810 may store program instructions that are loadable and executable by processing unit 1804. System memory 1810 may also store data that is used during the execution of the instructions and/or data that is generated during the execution of the program instructions. Various different kinds of programs may be loaded into system memory 1810 including but not limited to client applications, Web browsers, mid-tier applications, relational database management systems (RDBMS), virtual machines, containers, etc.

System memory 1810 may also store an operating system 1816. Examples of operating system 1816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1800 executes one or more virtual machines, the virtual machines along with their guest operating systems (GOSs) may be loaded into system memory 1810 and executed by one or more processors or cores of processing unit 1804.

System memory 1810 can come in different configurations depending upon the type of computer system 1800. For example, system memory 1810 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1810 may include a basic input/output system (BIOS) containing basic routines that help to transfer information between elements within computer system 1800, such as during start-up.

Computer-readable storage media 1822 may represent remote, local, fixed, and/or removable storage devices plus storage media for temporarily and/or more permanently containing, storing, computer-readable information for use by computer system 1800 including instructions executable by processing unit 1804 of computer system 1800.

Computer-readable storage media 1822 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1822 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1822 may include, but is not limited to, Zip® drives, flash memory cards, universal serial bus (USB) flash drives, secure digital (SD) cards, DVD disks, digital video tape, and the like. Computer-readable storage media 1822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1800.

Machine-readable instructions executable by one or more processors or cores of processing unit 1804 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1824 provides an interface to other computer systems and networks. Communications subsystem 1824 serves as an interface for receiving data from and transmitting data to other systems from computer system 1800. For example, communications subsystem 1824 may enable computer system 1800 to connect to one or more devices via the Internet. In some embodiments communications subsystem 1824 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1824 can provide wired network connectivity (e.g., Ethernet) in addition to or instead of a wireless interface.

In some embodiments, communications subsystem 1824 may also receive input communication in the form of structured and/or unstructured data feeds 1826, event streams 1828, event updates 1830, and the like on behalf of one or more users who may use computer system 1800.

By way of example, communications subsystem 1824 may be configured to receive data feeds 1826 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1824 may also be configured to receive data in the form of continuous data streams, which may include event streams 1828 of real-time events and/or event updates 1830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1824 may also be configured to output the structured and/or unstructured data feeds 1826, event streams 1828, event updates 1830, and the like to one or more databases that may be in communication with one or more streaming data source computers coupled to computer system 1800.

Computer system 1800 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1800 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving a natural language (NL) utterance;
generating a prompt including the NL utterance and instructions to transform the NL utterance into a logical form query including a coded-form expression;
generating, by a generative model based on the prompt, a logical form query including a coded-form expression;
transforming the coded-form expression into a period definition expression by executing the coded-form expression with one or more pre-defined period-definition content items;
updating the logical form query to include the period definition expression by replacing the coded-form expression with the period definition expression; and
providing at least one of i) the updated logical form query or ii) a query result obtained based on the updated logical form query, to a client system.

2. The computer-implemented method of claim 1, wherein prior to providing the query result to the client system, the computer-implemented method further comprises:
executing the updated logical form query on a query database to obtain the query result.

3. The computer-implemented method of claim 1, wherein the coded-form expression is an executable programming language function that is independent of at least one period definition expression.

4. The computer-implemented method of claim 1, wherein the instructions comprise:
a task description describing one or more time periods;
one or more period functions sharing a programming language format with the coded-form expression;
one or more gold truth examples including at least one gold truth logical form query, wherein each gold truth logical form query includes a gold truth coded-form expression; and
one or more additional instructions which provide context to the generative model relating to the task description, the one or more period functions, or the one or more gold truth examples.

5. The computer-implemented method of claim 1, wherein generating the logical form query further comprises:
generating, by the generative model, a first coded-form expression associated with a first portion of the NL utterance, wherein the first portion includes a first time period; and
generating, by the generative model, a second coded-form expression associated with a second portion of the NL utterance, wherein the second portion includes a second time period different from the first time period, and wherein the coded-form expression comprises the first coded-form expression and the second coded-form expression; and
generating, by the generative model, one or more composite operators associated with a programming language that the coded-form expression is formatted in, wherein the one or more composite operators operate on the first coded-form expression and the second coded-form expression to generate a composite coded-form expression; and
wherein transforming the coded-form expression into the period definition expression is based on the composite coded-form expression.

6. The computer-implemented method of claim 1, further comprising:
generating, by the generative model, one or more explanations associated with the updated logical form query; and
providing the one or more explanations to the client system.

7. The computer-implemented method of claim 1, wherein the pre-defined period definition content items are library content items associated with one or more programming languages.

8. A system comprising:
one or more processors; and
one or more computer-readable media storing instructions which, when executed by the one or more processors, cause the system to perform operations comprising:
generating a prompt including a NL utterance and instructions to transform the NL utterance into a logical form query including a coded-form expression;
generating, by a generative model based on the prompt, a logical form query including a coded-form expression, the coded-form expression associated with a programming language;
accessing one or more pre-defined period-definition content items comprising programming language code in the programming language that is associated with the coded-form expression;
transforming the coded-form expression into a period definition expression by executing the coded-form expression with the one or more pre-defined period-definition content items;
updating the logical form query to include the period definition expression by replacing the coded-form expression with the period definition expression; and
providing at least one of i) the updated logical form query or ii) a query result obtained based on the updated logical form query, to a client system.

9. The system of claim 8, wherein prior to providing the query result to the client system, the operations further comprise:
executing the updated logical form query on a query database to obtain the query result.

10. The system of claim 8, wherein the coded-form expression is an executable programming language function that is independent of at least one period definition expression.

11. The system of claim 8, wherein the instructions comprise a task description describing one or more time periods;
one or more period functions sharing a programming language format with the coded-form expression;
one or more gold truth examples including at least one gold truth logical form query, wherein each gold truth logical form query includes a gold truth coded-form expression; and
one or more additional instructions which provide context to the generative model relating to the task description, the one or more period functions, or the one or more gold truth examples.

12. The system of claim 8, wherein generating the logical form query further comprises:
generating, by the generative model, a first coded-form expression associated with a first portion of the NL utterance, wherein the first portion includes a first time period; and
generating, by the generative model, a second coded-form expression associated with a second portion of the NL utterance, wherein the second portion includes a second time period different from the first time period, and wherein the coded-form expression comprises the first coded-form expression and the second coded-form expression; and
generating, by the generative model, one or more composite operators associated with a programming language that the coded-form expression is formatted in, wherein the one or more composite operators operate on the first coded-form expression and the second coded-form expression to generate a composite coded-form expression; and
wherein transforming the coded-form expression into the period definition expression is based on the composite coded-form expression.

13. The system of claim 8, wherein the operations further comprise:
generating, by the generative model, one or more explanations associated with the updated logical form query; and
providing the one or more explanations to the client system.

14. The system of claim 8, wherein the pre-defined period definition content items are library content items associated with one or more programming languages.

15. One or more non-transitory computer-readable media storing instructions which, when executed by one or more processors, cause the one or more processors to perform operations comprising:
generating a prompt including a NL utterance and instructions to transform the NL utterance into a logical form query including a coded-form expression;
generating, by a generative model based on the prompt, a logical form query including a coded-form expression;
extracting the coded-form expression from the logical form query;
executing the coded-form expression with one or more pre-defined period-definition content items;
generating a period definition expression based on executing the coded-form expression with the one or more pre-defined period-definition content items; and
updating the logical form query to include the period definition expression by replacing the coded-form expression with the period definition expression.

16. The one or more non-transitory computer-readable media of claim 15, wherein prior to providing the query result to the client system, the computer-implemented method further comprises:
executing the updated logical form query on a query database to obtain the query result.

17. The one or more non-transitory computer-readable media of claim 15, wherein the coded-form expression is an executable programming language function that is independent of at least one period definition expression.

18. The one or more non-transitory computer-readable media of claim 15,
wherein the instructions comprise:
a task description describing one or more time periods;
one or more period functions sharing a programming language format with the coded-form expression;
one or more gold truth examples including at least one gold truth logical form query, wherein each gold truth logical form query includes a gold truth coded-form expression; and
one or more additional instructions which provide context to the generative model relating to the task description, the one or more period functions, or the one or more gold truth examples.

19. The one or more non-transitory computer-readable media of claim 15, wherein generating the logical form query further comprises:
generating, by the generative model, a first coded-form expression associated with a first portion of the NL utterance, wherein the first portion includes a first time period; and
generating, by the generative model, a second coded-form expression associated with a second portion of the NL utterance, wherein the second portion includes a second time period different from the first time period, and wherein the coded-form expression comprises the first coded-form expression and the second coded-form expression; and
generating, by the generative model, one or more composite operators associated with a programming language that the coded-form expression is formatted in, wherein the one or more composite operators operate on the first coded-form expression and the second coded-form expression to generate a composite coded-form expression; and
wherein transforming the coded-form expression into the period definition expression is based on the composite coded-form expression.

20. The one or more non-transitory computer-readable media of claim 15, wherein the operations further comprise:
generating, by the generative model, one or more explanations associated with the updated logical form query; and
providing at least one of i) the updated logical form query, ii) a query result, or iii) the one or more explanations, obtained based on the updated logical form query, to a client system.
